(19) United States
(12) Patent Application Publication
(10) Pub. No.: US 2005/0007904 A1
(43) Pub. Date: Jan. 13, 2005

(54) Tilt control method, program, recording medium, and optical disk drive

(76) Inventors: Yoshiyuki Ishiyama, Kanagawa (JP); Toshihiro Yamashiro, Kanagawa (JP); Yutaka Shio, Tottori (JP); Yasuhide Konishi, Tottori (JP)

Correspondence Address: DICKSTEIN SHAPIRO MORIN & OSHINSKY LLP, 2101 L Street, NW, Washington, DC, 20037, US

(21) Appl. No.: 10/841,520

(22) Filed: May 10, 2004

(30) Foreign Application Priority Data
May 12, 2003 (JP) 2003-133125

(51) Int. Cl. G11B 7/00

(52) U.S. Cl. 369/44.32; 369/53.19

(57) ABSTRACT

A tilt control method controls an inclination of an objective lens to an optical disk in which a track in the shape of a spiral or a concentric circle is formed. The tilt control method comprising steps of recording data to the optical disk, and acquiring, when recording the data to the optical disk, tilt control information for controlling the inclination of the objective lens based on both known compensation information that is defined with a plurality of kinds of signals acquired when reproducing data from a recorded region of the optical disk, and information that is related to an inclination of the objective lens when an amplitude of a tracking error signal is substantially a maximum in a recording region of the optical disk where the data are recorded.

### BACKGROUND OF THE INVENTION

1. Field of the Invention

The present invention generally relates to a tilt control method, a program, a recording medium and an optical disk drive, and more specifically to a tilt control method which controls the inclination of the objective lens to the optical disk, a program of the tilt control method applied to the optical disk drive, a recording medium embodied therein to cause a computer to execute the tilt control method, and the optical disk drive which accesses the optical disk and incorporates the tilt control method.

2. Description of the Related Art

With the improvement of the functions of personal computers, it has become possible for the computer to easily deal with the AV (audio-visual) information, such as music and images. Since the amount of the AV information is very large, the optical disks, such as CD (compact disc) and DVD (digital versatile disc), have come to attract the attention as an information recording medium. With the production of inexpensive optical disks, the optical disk drives which access the optical disks have come to spread.

In the optical disk drive, the laser beam is irradiated at the recording surface of the optical disk in which the track in the spiral or concentric circle shape is formed, so that the recording and deleting of the information is carried out. Moreover, in the optical disk drive, the reproducing of the information is performed based on the reflected light from the recording surface of the optical disk.

The optical disk drive is equipped with the optical pickup device as a device for receiving the reflected light from the recording surface while it irradiates the laser beam and forms the optical spot on the recording surface of the information recording medium.

Usually, the optical pickup device is equipped with the optical system which draws the reflected light (the return light beam) from the recording surface to the predetermined light-receiving position, the light-receiving element which is arranged in the light-receiving position and receives the return light beam while it leads the laser beam which are outputs from the light source to the recording surface of the optical disk including the objective lens.

From the light-receiving element, the signal including the reproduction information on the data currently recorded on the recording surface, and the signal including the information (servo information) required for the positional control of the objective lens and the optical pickup device itself, etc. are outputted.

However, when there is a deviation (which is called the “tilt”) in the direction of the optical axis of the objective lens from the direction perpendicular to the recording surface, the wave aberration is caused by the tilt, and there is a possibility of causing the degradation of the form of the optical spot and the degradation of the signals including the reproduction information, the servo information, etc. which are outputted from the light-receiving element.

To obviate the problem, several methods and devices for correcting the tilt are proposed, as disclosed, for example, in Japanese Laid-Open Patent Application No. 2001-052362 and Japanese Laid-Open Patent Application No. 2002-025090.

In recent years, the efforts for the higher recording density have been made with the demand for increasing the storage capacity of the information recording medium. It is necessary to make small the diameter of the optical spot formed on the recording surface of the optical disk in order to make the recording density high, and there is the tendency that the objective lens with a large numerical aperture is used more frequently.

However, if the numerical aperture of the objective lens becomes large, the influence of the wave aberration resulting from the tilt will not be negligible, and there is a possibility that the measures adequate for correcting the tilt cannot be taken with the devices disclosed in Japanese Laid-Open Patent Application No. 2001-052362 and Japanese Laid-Open Patent Application No. 2002-025090.

### SUMMARY OF THE INVENTION

An object of the present invention is to provide an improved tilt control method in which the above-described problems are eliminated.

Another object of the present invention is to provide a tilt control method that can control the inclination of the objective lens to the optical disk with sufficient precision without causing the fall of performance.

Another object of the present invention is to provide a computer program product embodied to cause a computer to execute the tilt control method that can control the inclination of the objective lens to the optical disk with sufficient precision without causing the fall of performance.

Another object of the present invention is to provide an optical disk drive that can stably access the optical disk with good response and incorporates the tilt control method that can control the inclination of the objective lens to the optical disk with sufficient precision without causing the fall of performance.

The above-mentioned objects of the present invention are achieved by a tilt control method which controls an inclination of an objective lens to an optical disk in which a track in the shape of a spiral or a concentric circle is formed, the tilt control method comprising steps of: recording data to the optical disk; and acquiring, when recording the data to the optical disk, tilt control information for controlling the inclination of the objective lens based on both known compensation information that is defined with a plurality of kinds of signals acquired when reproducing data from a recorded region of the optical disk, and information that is related to an inclination of the objective lens when an amplitude of a tracking error signal is substantially a maximum in a recording region of the optical disk where the data are recorded.

The above-mentioned objects of the present invention are achieved by a tilt control method which controls an inclination of an objective lens to an optical disk in which a track in the shape of a spiral or a concentric circle is formed, the tilt control method comprising steps of: reproducing data from the optical disk; and controlling, when reproducing the data from the optical disk, the inclination of the objective lens based on tilt control information acquired near a central part of the track of the optical disk.

The above-mentioned objects of the present invention are achieved by a computer program product embodied therein to cause a computer of an optical disk drive to execute a tilt control method which controls an inclination of an objective lens to an optical disk in which a track in the shape of a spiral or a concentric circle is formed, the method comprising steps of: recording data to the optical disk; acquiring, when recording the data to the optical disk, known compensation information that is defined with a plurality of kinds of signals acquired when reproducing data from a recorded region of the optical disk; and acquiring tilt control information for controlling the inclination of the objective lens based on both the known compensation information and information that is related to an inclination of the objective lens when an amplitude of a tracking error signal is substantially a maximum in a recording region of the optical disk where the data are recorded.

The above-mentioned objects of the present invention are achieved by a computer program product embodied therein to cause a computer of an optical disk drive to execute a tilt control method which controls an inclination of an objective lens to an optical disk in which a track in the shape of a spiral or a concentric circle is formed, the method comprising steps of: reproducing data from the optical disk; acquiring, when reproducing the data from the optical disk, tilt control information acquired near a central part of the track of the optical disk and provided for controlling the inclination of the objective lens; and controlling the inclination of the objective lens based on the acquired tilt control information.

The above-mentioned objects of the present invention are achieved by an optical disk drive which accesses an optical disk in which a track in the shape of a spiral or a concentric circle is formed, the optical disk drive configured to control an inclination of an objective lens to the optical disk and comprising: a tilt control information acquisition unit acquiring, when recording data to the disk, tilt control information for controlling the inclination of the objective lens based on both known compensation information that is defined with a plurality of kinds of signals acquired when reproducing data from a recorded region of the optical disk, and information that is related to an inclination of the objective lens when an amplitude of a tracking error signal is substantially a maximum in a recording region of the optical disk where the data are recorded; an optical pickup device irradiating a light beam to a recording surface of the disk and receiving a reflected light from the recording surface of the disk; and a processing unit performing at least recording of the data to the disk by using an output signal of the optical pickup device.

The above-mentioned objects of the present invention are achieved by an optical disk drive which accesses an optical disk in which a track in the shape of a spiral or a concentric circle is formed, the optical disk drive configured to control an inclination of an objective lens to the optical disk and comprising: an inclination control unit controlling, when reproducing data from the disk, the inclination of the objective lens based on tilt control information acquired near a central part of the track of the optical disk; an optical pickup device irradiating a light beam to a recording surface of the disk and receiving a reflected light from the recording surface of the disk; and a processing unit performing at least reproducing of the data from the disk by using an output signal of the optical pickup device.

According to the tilt control method of the present invention, it is effectively possible to correct the inclination of the objective lens to the optical disk with sufficient precision without causing the fall of performance. Moreover, according to the computer program product of the present invention for control of the optical disk drive, it is effectively possible to correct the inclination of the objective lens to the optical disk with sufficient precision without causing the fall of performance. Moreover, according to the optical disk drive of the present invention, it is possible to stably perform the accessing of the optical disk with good response.

### BRIEF DESCRIPTION OF THE DRAWINGS

Other objects, features and advantages of the present invention will be apparent from the following detailed description when reading in conjunction with the accompanying drawings.

FIG. 1 is a block diagram of an optical disk drive to which an embodiment of the invention is applied.

FIG. 2 is a block diagram of the read signal processing circuit in the optical disk drive of FIG. 1.

FIG. 3A is a diagram for explaining the zone division for the tilt control at the time of recording, and FIG. 3B is a diagram for explaining the zone division for the tilt control at the time of reproducing.

FIG. 4 is a diagram showing the composition of the optical pickup device in the optical disk drive of FIG. 1.

FIG. 5 is a diagram showing the composition of the light-beam output system in the optical pickup device of FIG. 4.

FIG. 6 is a diagram showing the composition of the focusing system in the optical pickup device of FIG. 4.

FIG. 7 is a cross-sectional view of the focusing system taken along the line A-A indicated in FIG. 6.

FIG. 8A is a diagram showing the guide shaft fixing part in the focusing system of FIG. 6, and FIG. 8B is a diagram showing the lens holder and line spring fixing part in the focusing system of FIG. 6.

FIG. 9 is a flowchart for explaining the processing operation of the invention to acquire the tilt move amount for each zone when the TE amplitude is the maximum, which is performed at the time of loading the optical disk.

FIG. 10 is a flowchart for explaining the processing operation of the invention to acquire the tilt move amount for each zone when the TE amplitude is the maximum, which is performed at the time of loading the optical disk.

FIG. 11 is a flowchart for explaining the processing operation of the invention which is performed at the time of receiving the record request command.

FIG. 12 is a flowchart for explaining the processing operation of the invention which is performed at the time of receiving the record request command.

FIG. 13 is a flowchart for explaining the processing operation of the invention which is performed at the time of receiving the record request command.

FIG. 14A is a diagram for explaining the tilt move amount when the TE amplitude is the maximum, and FIG. 14B is a diagram for explaining the tilt move amount when the RF amplitude is the maximum.

FIG. 15 is a flowchart for explaining the processing operation of the invention which is performed at the time of receiving the reproduce request command.

FIG. 16A, FIG. 16B and FIG. 16C are diagrams for explaining the tilt control system when the recording zone is overlapped over the write zones.

FIG. 17A and FIG. 17B are diagrams for explaining the tilt control signal when the recording zone is overlapped over the write zones.

FIG. 18 is a block diagram of the read signal processing circuit when the jitter is used instead of the RF amplitude.

FIG. 19A is a diagram for explaining the tilt move amount when the TE amplitude is the maximum, and FIG. 19B is a diagram for explaining the tilt move amount when the jitter is the minimum.

FIG. 20 is a block diagram of the read signal processing circuit when the B-value is used instead of the beta value.

### DETAILED DESCRIPTION OF PREFERRED EMBODIMENTS

A description will now be given of the preferred embodiments of the invention with reference to the accompanying drawings.

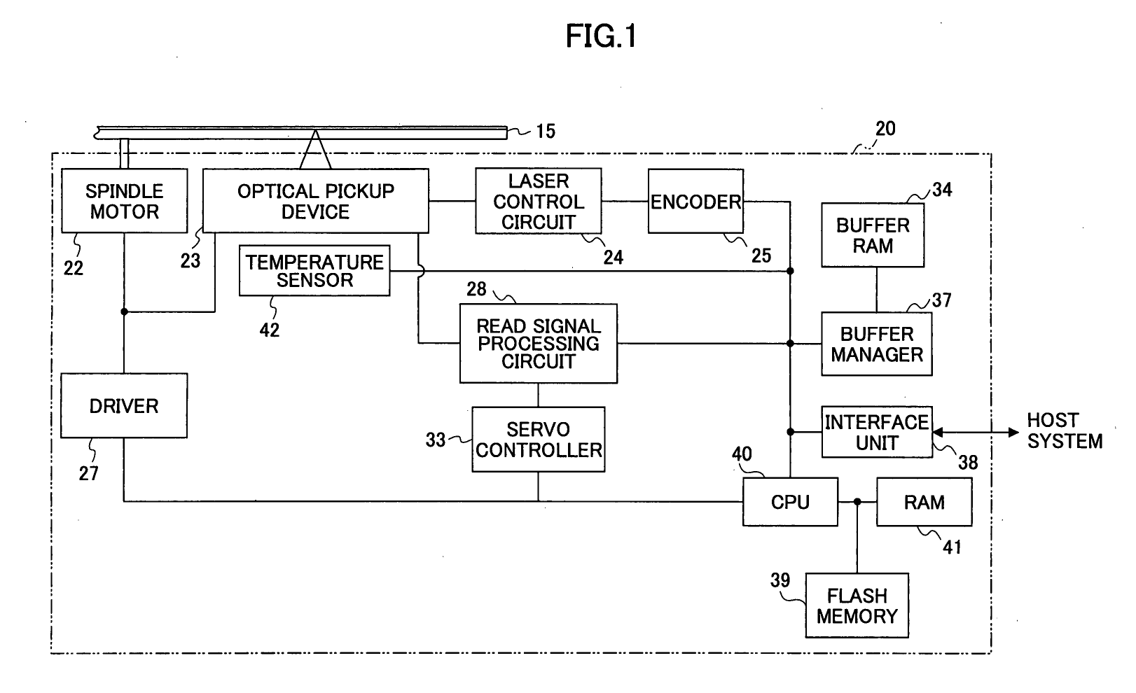

FIG. 1 shows the composition of the optical disk drive to which an embodiment of the present invention is applied.

As shown in FIG. 1, the optical disk drive 20 comprises the spindle motor 22 for carrying out the rotation drive of the optical disk 15, the optical pickup device 23, the laser control circuit 24, the encoder 25, the driver 27, the read signal processing circuit 28, the servo controller 33, the buffer RAM 34, the buffer manager 37, the interface unit 38, the flash memory 39, the CPU 40, the RAM 41 as the main memory, and the temperature sensor 42 as the temperature detection unit.

In addition, the connection line in FIG. 1 merely shows the typical signal or the typical information flow, but it does not express all the related connections of each block. Moreover, in the present embodiment, the optical disk based on the specifications of the DVD system is used as a typical example.

The optical pickup device 23 is the device for receiving the reflected light from the recording surface while irradiating the laser beam in the predetermined position of the recording surface of the optical disk 15 in which the track in the spiral or concentric circle shape is formed. The composition of the optical pickup device 23 will be described later.

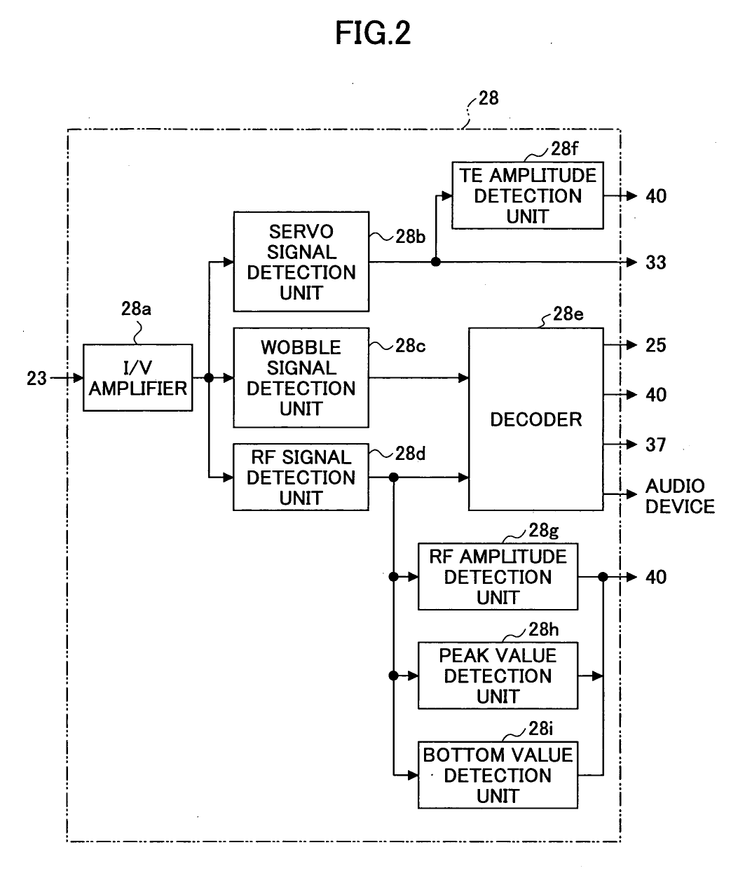

FIG. 2 shows the composition of the read signal processing circuit 28 in the optical disk drive 20 of FIG. 1.

As shown in FIG. 2, the read signal processing circuit 28 comprises the I/V amplifier 28a, the servo-signal detection unit 28b, the wobble-signal detection unit 28c, the RF signal detection unit 28d, the decoder 28e, the TE amplitude detection unit 28f, the RF amplitude detection unit 28g, the peak value detection unit 28h, and the bottom value detection unit 28i.

The I/V amplifier 28a converts, into the voltage signal, the current signal which is the output signal of the optical pickup device 23, and amplifies the voltage signal by a predetermined gain. The servo-signal detection unit 28b detects the servo signals (the focusing error signal, the tracking error signal, etc.) based on the output signal of the I/V amplifier 28a. The servo signals detected by the servo-signal detection unit 28b are outputted to the servo controller 33.

The wobble-signal detection unit 28c detects the wobble signal based on the output signal of the I/V amplifier 28a. The RF signal detection unit 28d detects the RF signal based on the output signal of the I/V amplifier 28a. The decoder 28e extracts the ADIP (address in pregroove) information, the sync signal, etc. from the wobble signal detected by the wobble-signal detection unit 28c. The ADIP information extracted here is outputted to the CPU 40, and the sync signal is outputted to the encoder 25.

Moreover, the decoder 28e performs the decoding processing, the error correction processing, etc. to the RF signal detected by the RF signal detection unit 28d. After this, the decoder 28e stores the reproduction data in the buffer RAM 34 through the buffer manager 37 as the results of the decode processing.

In addition, when the reproduction data are music data, the reproduction data after the D/A conversion is carried out are outputted to the external audio device.

The TE amplitude detection unit 28f detects the TE amplitude which is the amplitude of the tracking error signal detected by the servo-signal detection unit 28b. The TE amplitude detected here is outputted to the CPU 40. The RF amplitude detection unit 28g detects the RF amplitude which is the amplitude of the RF signal detected by the RF signal detection unit 28d. The RF amplitude detected here is outputted to the CPU 40.

The peak value detection unit 28h detects the peak level of the RF signal detected by the RF signal detection unit 28d, and outputs the peak level to the CPU 40. The bottom value detection unit 28i detects the bottom level of the RF signal detected by the RF signal detection unit 28d, and outputs the bottom level to the CPU 40.

Referring back to FIG. 1, the servo controller 33 creates the control signal (called “the focal control signal”) for correcting the focal deviation based on the focusing error signal from the read signal processing circuit 28, and creates the control signal (called the “tracking control signal”) for correcting the track deviation based on the tracking error signal from the read signal processing circuit 28.

Each control signal which is created by the servo controller 33 is outputted to the driver 27 only in the condition of the servo-on, and is not outputted to the driver 27 in the condition of the servo-off. The condition of the servo-on or the servo-off is set up for every control signal by the CPU 40.

The driver 27 outputs the drive current (called the “focal drive current”) according to the focal control signal from the servo controller 33, to the optical pickup device 23, and outputs the drive current (called the “tracking drive current”) according to the tracking control signal from the servo controller 33, to the optical pickup device 23.

Moreover, the driver 27 outputs the drive current (called the “tilt drive current”) according to the tilt control signal from the CPU 40, to the optical pickup device 23, and outputs the drive signal (called the “seeking drive signal”) according to the seeking control signal from the CPU 40, to the optical pickup device 23. Furthermore, the driver 27 outputs the drive signal to the spindle motor 22 based on the instructions from the CPU 40.

The buffer RAM 34 comprises the buffer region where the data (the recording data) being recorded to the optical disk, and the data (the reproduction data) reproduced from the optical disk are stored temporarily, and the variable region where the various programming variables are stored.

The buffer manager 37 manages the I/O (input and output) of the data to and from the buffer RAM 34. When the amount of the data accumulated in the buffer region reaches a predetermined quantity, the buffer manager 37 notifies the overflow of the data in the buffer RAM 34 to the CPU 40.

The encoder 25 takes out the recording data accumulated in the buffer region of the buffer RAM 34 based on the instructions from the CPU 40 through the buffer manager 37, and performs the predetermined data modulation processing and the error correction code adding processing. Thereby, the encoder 25 creates the write-in signal being outputted to the optical disk 15, and, in synchronization with the sync signal from the read signal processing circuit 28, outputs the write-in signal to the laser control circuit 24.

The laser control circuit 24 outputs the control signal (called the “LD control signal”), which controls the output of the laser beam which is irradiated to the optical disk 15, to the optical pickup device 23 based on the write-in signal from the encoder 25 and the instructions from the CPU 40.

The temperature sensor 42 is arranged near the optical pickup device 23, detects the temperature information near the optical pickup device 23, and outputs the detection result to the CPU 40.

The interface unit 38 is the bi-directional communication interface with the host system (for example, the personal computer), and it is, for example, in conformity with the specifications of ATAPI (advanced technology attachment packet interface).

The flash memory 39 is comprised of the program region and the data region. The flash memory 39 is a non-volatile memory, and the contents stored in the flash memory 39 are retained even if the power supply to the flash memory 39 is stopped.

The programs, including the program (called the tilt control program) of the present invention used when the tilt control is performed which is described with the codes recognizable to the CPU 40, are stored in the program region of the flash memory 39.

The track division method when performing the tilt control is stored in the data region of the flash memory 39 as the track division information.

The track division information includes the division information at the time of recording, and the division information at the time of reproduction, respectively.

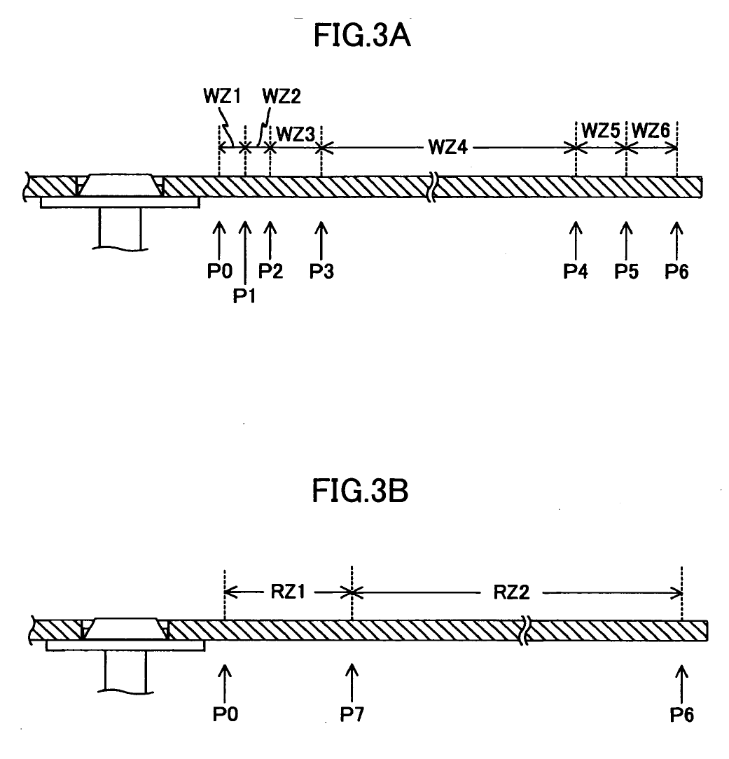

FIG. 3A shows the zone division for the tilt control at the time of recording.

As shown in FIG. 3A, the track is divided into the six regions (each called the “write zone”) at the time of recording, so that the tilt control is performed. The write zone WZ1 is the region where the distance P from the rotation center of the optical disk is in the range of P0≦P<P1. The write zone WZ2 is the region where the distance P is in the range of P1≦P<P2. The write zone WZ3 is the region where the distance P is in the range of P2≦P<P3. The write zone WZ4 is the region where the distance P is in the range of P3≦P<P4. The write zone WZ5 is the region where the distance P is in the range of P4≦P<P5. The write zone WZ6 is the region where the distance P is in the range of P5≦P<P6.

For example, in the optical disk drive built into the notebook personal computer, the optical disk is held on the turntable by pushing operation of the user, and the curvature of the optical disk near the rotation center of the optical disk becomes large. Moreover, there is the tendency that the optical disk hangs down by the self-weight near the outer periphery of the optical disk. For this reason, the write zones are set up such that the write zone near the rotation center of the optical disk and the write zone near the outer periphery are relatively narrow. In addition, the positional relation conditions: P0<P1<P2<P3<P4<P5<P6 are satisfied.

Moreover, FIG. 3B shows the zone division for the tilt control at the time of reproducing.

As shown in FIG. 3B, the track is divided into the two regions (each called the “read zone”) at the time of reproduction, so that the tilt control is performed. The read zone RZ1 is the region where the distance P is in the region of P0≦P<P7, and the read zone RZ2 is the region where the distance P is in the range of P7≦P<P6. The curvature of the optical disk near the rotation center of the optical disk is large, and the read zones RZ1 and RZ2 are set up such that the read zone RZ1 is narrower than the read zone RZ2.

Moreover, the difference between the optimal inclination of the objective lens at the time of reproduction and the optimal inclination of the objective lens at the time of recording is obtained by the experiments etc., in advance, and it is stored in the data region of the flash memory 39 as the read offset value.

The CPU 40 controls operation of each part of the optical disk drive 20 according to the program stored in the program region of the flash memory 39, and stores the data required for the control in the RAM 41 and the buffer RAM 34.

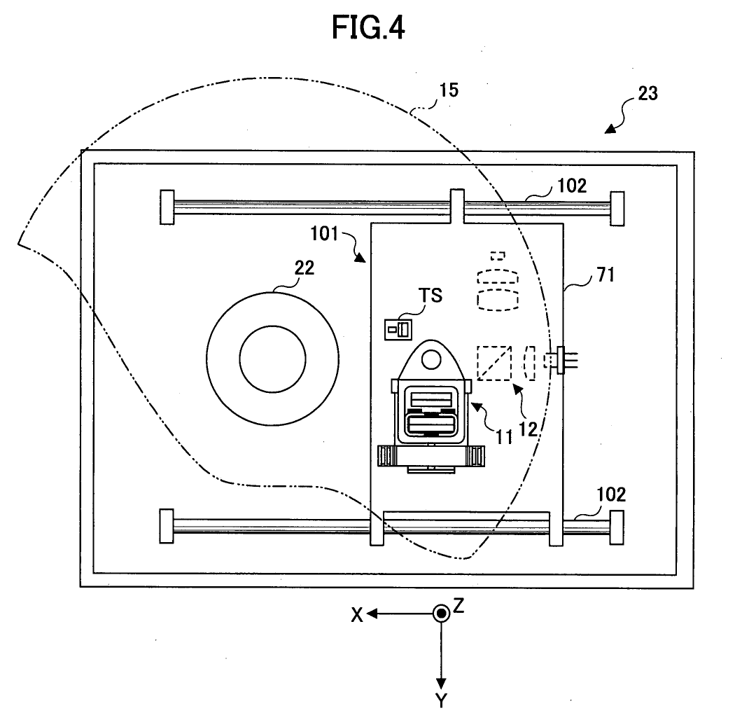

Next, the composition of the optical pickup device 23 will be explained using FIG. 4 to FIG. 8B.

As shown in FIG. 4, the optical pickup device 23 includes the pickup main part 101 which irradiates the laser beam on the recording surface of the optical disk 15 which is rotated by the spindle motor 22 and receives the reflected light from the recording surface of the optical disk 15, the two seek rails 102 which hold the pickup main part 101 and guide the movement of the pickup main part 101 to the X-axis direction (the right-and-left direction in FIG. 4), and the seeking motor (not shown) for driving the pickup main part 101 to the X-axis direction.

The pickup main part 101 includes the housing 71, the light-beam output system 12 which is held in the interior of the housing 71 and serves to output the light beam to irradiate the recording surface of the optical disk 15, and the focusing system 11 which is arranged on the housing 71 and focuses the light beam from the light-beam output system 12 at the predetermined position of the recording surface of the optical disk 15.

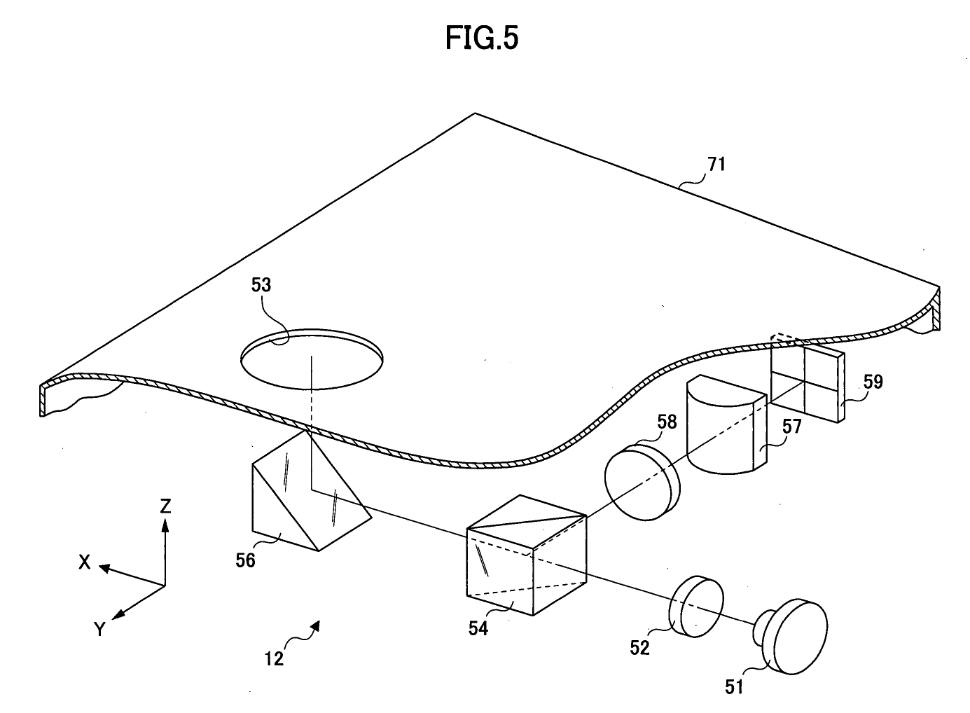

FIG. 5 shows the composition of the light-beam output system 12. The light-beam output system 12 includes the light source unit 51, the coupling lens 52, the beam splitter 54, the starting mirror 56, the detection lens 58, the cylindrical lens 57, the photodetector 59, etc. as shown in FIG. 5.

The light source unit 51 includes the semiconductor laser (not shown) as the light source which emits the light beam the wavelength of which is 660 nm, and the light source unit 51 is fixed to the housing 71 so that the direction of maximum intensity output of the light beam (called the “outgoing beam”) which is outputted from the light source unit 51 accords with the direction of +X.

The coupling lens 52 is arranged at the +X side of the light source unit 51, and converts the outgoing beam into the generally parallel light. The beam splitter 54 is arranged at the +X side of the coupling lens 52, and branches the reflected light (the return light beam) from the recording surface of the optical disk 15 in the direction of −Y. The starting mirror 56 is arranged at the +X side of the beam splitter 54, and changes the direction of maximum intensity output of the outgoing beam, which passes through the beam splitter 54, to the direction of +Z. The outgoing beam in which the direction of direction of maximum intensity output is changed to the direction of +Z by the starting mirror 56 is incident to the focusing system 11 through the opening 53 provided in the housing 71.

The detection lens 58 is arranged at the −Y side of the beam splitter 54, and focuses the return light beam which is branched to the direction of −Y by the beam splitter 54. The cylindrical lens 57 is arranged at the −Y side of the detection lens 58, and shapes the return light beam focused with the detection lens 58. The photodetector 59 is arranged at the −Y side of the cylindrical lens 57, and receives the return light beam shaped with the cylindrical lens 57 at the light-receiving element. The photodetector 59 uses the 4 division light-receiving element similar to the conventional optical disk drive, and the signal (current signal) according to the amount of light-receiving is outputted to the read signal processing circuit 28, respectively from each division region (called the partial light-receiving element). The optical path for leading the light beam outputted from the light source unit 51 to the focusing system 11, and the optical path for leading the return light beam to the photodetector 59 are formed in the interior of the housing 71.

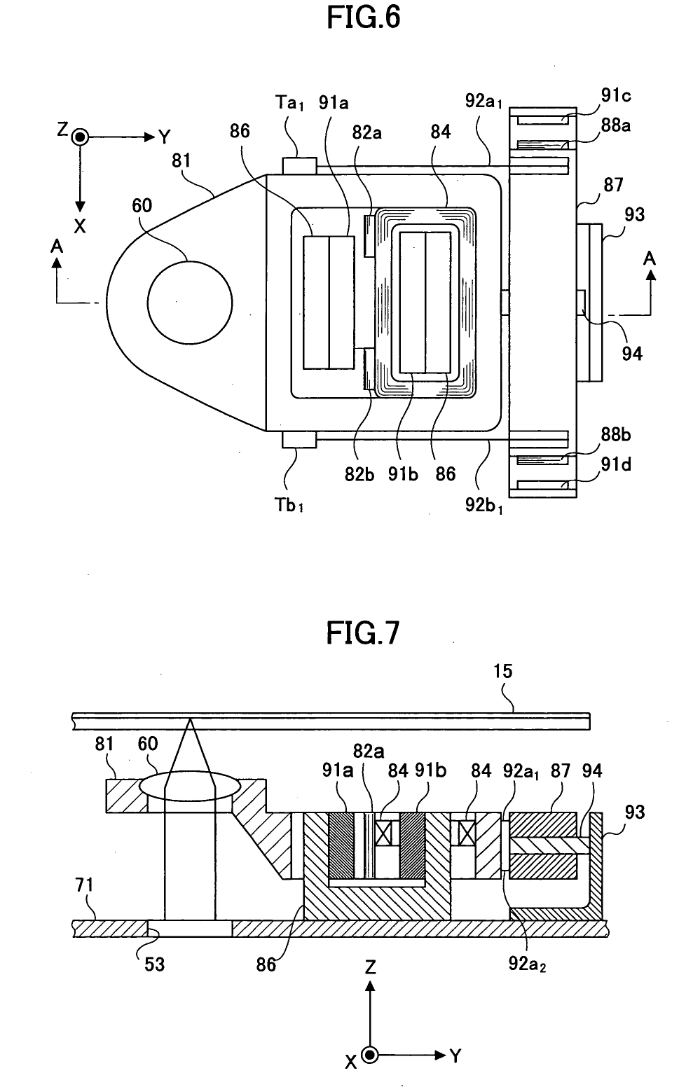

FIG. 6 shows the composition of the focusing system 11. FIG. 7 is a cross-sectional view of the focusing system 11 taken along the line A-A indicated in FIG. 6. As shown in FIG. 6 and FIG. 7, the focusing system 11 includes the objective lens 60, the lens holder 81

They are the coil for the tracking of 81 or 2 lens holders which hold the objective lens 60 and the objective lens 60 as the focusing system 11 is shown in FIG. 7 which is the A-A line sectional view in FIG. 6 and FIG. 6 (82a, 82b), the coil 84 for the focusing, and the yoke. It comprises from the 86 or 2 coils for the tilts (88a, 88b), the four permanent magnets (91a, 91b, 91c, 91d), four line springs (92a1, 92a2, 92b1, 92b2) that have the conductivity, the line spring fixing part 87, the guide shaft 94, the guide shaft fixing part 93, etc.

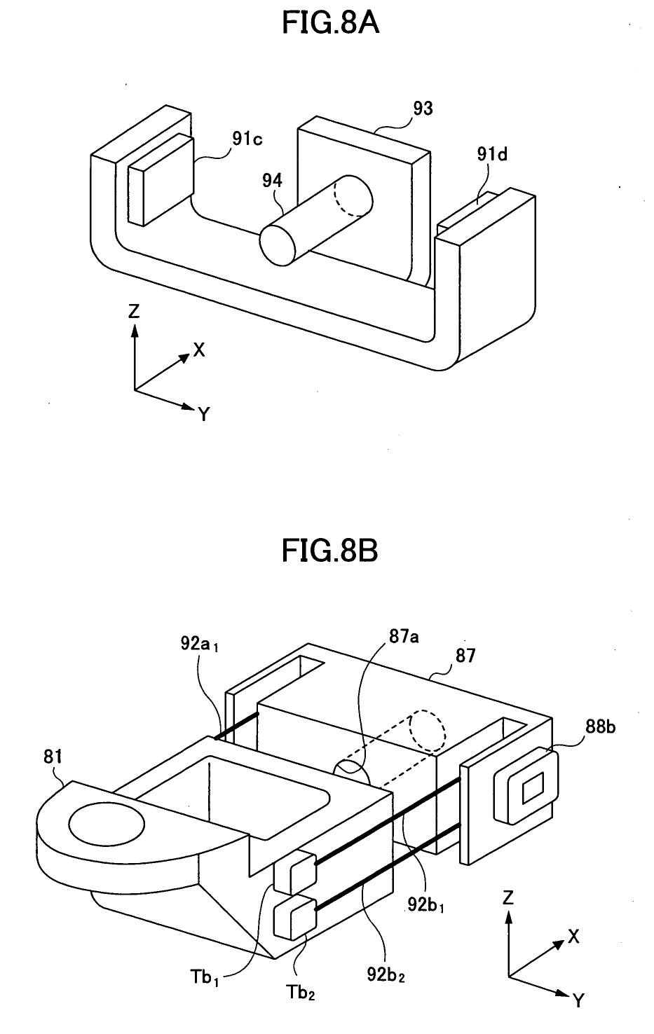

As shown in FIG. 8A, the guide shaft fixing part 93 is a member which has the bottom wall and the side walls (the +Y side, the −X side, and the +X side) extending from the bottom wall in the Z-axis direction. The bottom wall is fixed to the predetermined position on the housing 71.

In the following, the side wall by the side of +Y is called the 1st fixed side wall, the side wall by the side of −X is called the 2nd fixed side wall, and the side wall by the side of +X is called the 3rd fixed side wall. In the surface by the side of −Y of the 1st fixed side wall, the guide shaft 94 of the cylindrical configuration is arranged, so that the direction of the length and the Y-axis direction are mostly in agreement with each other. Moreover, the permanent magnet 91c is arranged in the surface by the side of +X of the 2nd fixed side wall, and the 91d of the permanent magnets is arranged in the surface by the side of −X of the 3rd fixed side wall. In addition, the permanent magnet 91c and the permanent magnet 91d have the same configuration and the same magneto property.

The line spring fixing part 87 is provided with the plurality of input terminals and the plurality of output terminals (not shown). The plurality of signal lines of the driver 27 are connected to each input terminal, respectively, and the focal drive current, the tracking drive current, the tilt drive current, etc. are inputted.

Moreover, the opening 87a of the cylinder form prolonged in the Y-axis direction as shown in FIG. 8B is formed in the central part of the line spring fixing part 87. And the guide shaft 94 is inserted in the opening 87a.

Furthermore, the two coils for the tilts (88a, 88b) are arranged in the predetermined position at the line spring fixing part 87, respectively. They have the almost same configuration. If the drive current is supplied to each coil for the tilts, each coil for the tilts is arranged in the position where coil 88a for the tilts counters the permanent magnet 91c, and in the position where coil 88b for the tilts counters the permanent magnet 91d so that the turning effort for rotating the line spring fixing part 87 to the circumference of the guide shaft 94 occurs. In addition, the rotation direction can be controlled by the direction of the drive current which flows in each coil for the tilts. Moreover, each coil for the tilts has the size and configuration according to the turning effort needed, respectively.

The lens holder 81 is arranged in the position the direction of maximum intensity output of the outgoing beam from the light-beam output system 12 and whose optical axis of the objective lens 60 correspond mostly.

The two coils for the tracking (82a, 82b) and the coil 84 for the focusing are fixed to this lens holder 81 by the predetermined position, respectively. In addition, since the objective lens 60, the lens holder 81, each coil for the tracking, and the coil 84 for the focusing are united and are moved. In the following, the integral member of these parts is called the moving part. In addition, in FIG. 8B, the illustration of each coil for the tracking and the coil 84 for the focusing is omitted.

Moreover, the terminal (referred to as Ta2 and Tb2) for supplying drive current to the terminal (referred to as Ta1 and Tb1) and the coil for the focusing for supplying drive current to each coil for the tracking is provided in the lens holder 81. Here, the terminals Ta1 and Ta2 are formed in the surface by the side of −X of the lens holder 81, and the terminals Tb1 and Tb2 are formed in the surface by the side of +X of the lens holder 81.

And the end of the line spring 92a1 is connected to the terminal Ta1, and the end of the line spring 92a2 is connected to the terminal Ta2. Moreover, the end of the line spring 92b1 is connected to the terminal Tb1, and the end of the line spring 92b2 is connected to the terminal Tb2.

Each line spring is prolonged in the Y-axis direction, and the other ends thereof are connected to the predetermined output terminal of the line spring fixing part 87 by soldering, respectively. Namely, the moving part is resiliently supported by the line spring fixing part 87 through the four line springs. Therefore, when the line spring fixing part 87 is rotated around the guide shaft 94, the moving part is also rotated together with the line spring fixing part 87.

Referring back to FIG. 7, the yoke 86 is a member which has the bottom wall and the side walls (the −Y side and the +Y side) extending from the bottom wall in the Z-axis direction. The bottom wall is fixed to the predetermined position on the housing 71.

In the following, the side wall by the side of −Y is called the 1st yoke side wall, and the side wall by the side of +Y is called the 2nd yoke side wall.

The permanent magnet 91a is arranged in the surface by the side of +Y of the 1st yoke side wall, and the permanent magnet 91b is arranged in the surface by the side of −Y of the 2nd yoke side wall.

The coil 84 for the focusing is arranged in the position where the 2nd yoke side wall and the permanent magnet 91b are wound, so that the supply of drive current causes the driving force for driving the moving part in the direction of +Z (or the direction of −Z) to occur. In addition, the drive direction (the direction of +Z or the direction of −Z) can be controlled by the direction of the flowing drive current in the coil 84 for the focusing. Moreover, the coil 84 for the focusing has the size and configuration according to the driving force needed.

The two coils for the tracking (82a, 82b) are arranged in the positions where they counter the permanent magnet 91a, respectively, so that the supply of drive current causes the driving force for driving the moving part in the direction of +X (or the direction of −X) to occur. In addition, the drive direction (the direction of +X or the direction of −X) can be controlled by the direction of the drive current flowing through in each of the coils for the tracking. Moreover, each coil for the tracking has the size and configuration according to the driving force needed.

Next, a description will be given of the respective operations of the optical pickup device 23 when the LD control signal, the focal drive current, the tracking drive current, the tilt drive current, and the seeking drive signal are supplied to the optical pickup device 23, respectively.

In addition, the optical pickup device 23 is carried on the optical disk drive 20 so that the direction perpendicular to the recording surface of the optical disk 15 matches with the Z-axis direction, and the tangential direction of the track in the optical disk 15 matches with the Y-axis direction. That is, the X-axis direction accords with the tracking direction, and the Z-axis direction accords with the focusing direction.

A description will now be given of the LD control signal. The LD control signal from the laser control circuit 24 is inputted to the light source unit 51, and the light beam of the power according to LD control signal are outputs it in the direction of +X from the light source unit 51. After the light beam (outgoing beam) serves as the generally parallel light with the coupling lens 52, it is incident to the beam splitter 54. It is reflected in the direction of +Z by the starting mirror 56, and the outgoing beam passing through the beam splitter 54 is incident to the focusing system 11 through the opening 53 of the housing 71. The outgoing beam incident to the focusing system 11 is focused by the objective lens 60 into the small spot at the recording surface of the optical disk 15.

The reflected light from the recording surface of the optical disk 15 is again made into the generally parallel light with the objective lens 60 as a return light beam, is started through the opening 53 of housing 71, and it is incident to the mirror 56. It is reflected in the direction of −X and the return light beam incident to the starting mirror 56 is incident to the beam splitter 54. The return light beam branched in the direction of −Y by the beam splitter 54 is received by the photodetector 59 through the detection lens 58 and the cylindrical lens 57.

Each partial light-receiving element which constitutes the photodetector 59 outputs the current signal according to the amount of light-receiving to the read signal processing circuit 28, respectively.

Next, a description will be given of the focus drive current. It is inputted to the predetermined input terminal of the line spring fixing part 87, the line spring 92a2 and the line spring 92b2 are minded, and the focal drive current from the driver 27 is supplied to the coil 84 for the focusing.

And according to the magnitude and the direction of the focal drive current, the moving part is driven in the direction of the focusing. Thereby, the objective lens 60 is shifted in the direction of the focus, and the focal deviation is corrected. In addition, if the supply of focal drive current is stopped, the moving part is returned to the predetermined criteria position (the focal criteria position) about the direction of the focusing.

Next, a description will be given of the tracking drive current. The tracking drive current from the driver 27 is inputted into the predetermined input terminal of the line spring fixing part 87, and is supplied to each coil for the tracking through the line spring 92a1 and the line spring 92b1. And according to the size of tracking drive current, and the direction, moving part drives to the tracking direction. Thereby, the objective lens 60 is shifted to the tracking direction, and the track deviation is corrected. In addition, if supply of tracking drive current is stopped, moving part will return to the predetermined criteria position (tracking criteria position) about the tracking direction.

Next, a description will be given of the tilt drive current. The tilt drive current from the driver 27 is inputted into the predetermined input terminal of the line spring fixing part 87, and is supplied to each coil for the tilts through the predetermined output terminal. And according to the magnitude and direction of the tilt drive current, the moving part is rotated to the circumference of the guide shaft 94 with the line spring fixing part 87. Thereby, the objective lens 60 rotates in XZ side, and the tilt is corrected.

In addition, if supply of tilt drive current is stopped, the line spring fixing part 87 and moving part will return to the predetermined criteria position (tilt criteria position) about the inside of XZ side. Moreover, the tilt angle within XZ side of the objective lens 60 to the tilt criteria position is called the amount of tilt move.

Next, a description will be given of the seeking drive signal. The seeking drive signal from the driver 27 is supplied to the non-illustrated seeking motor. Thereby, the pickup main part 101 moves to the X-axis direction while it is guided on the seek rail 102. When the supply of the seeking drive signal is stopped, the position of the pickup main part 101 at the time of stopping is maintained.

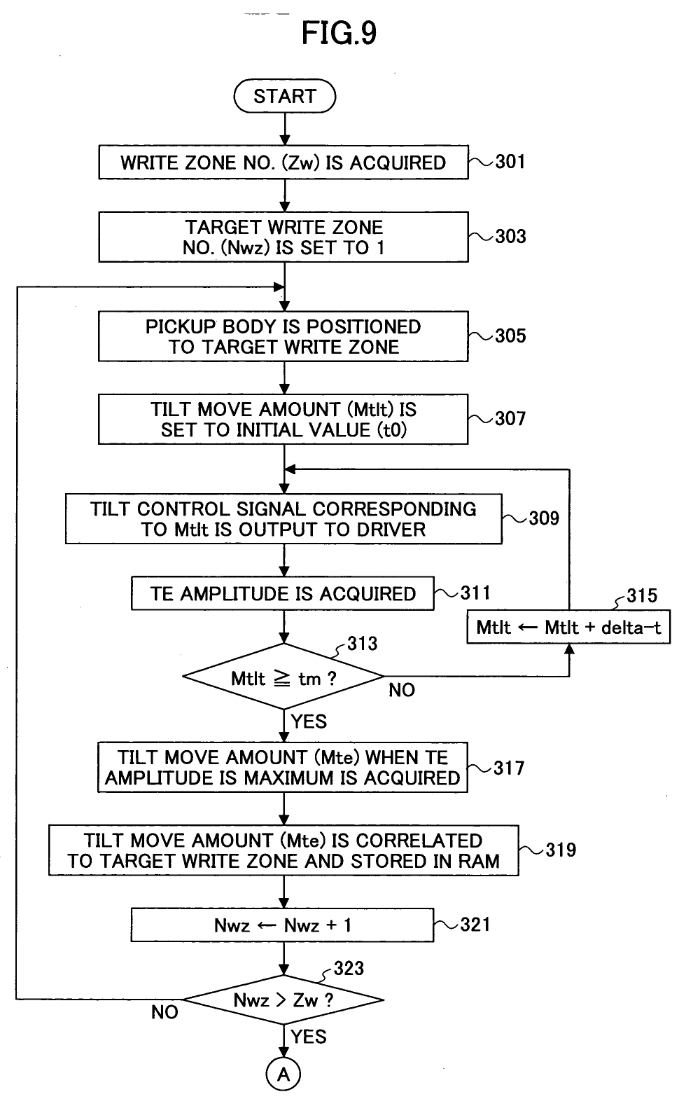

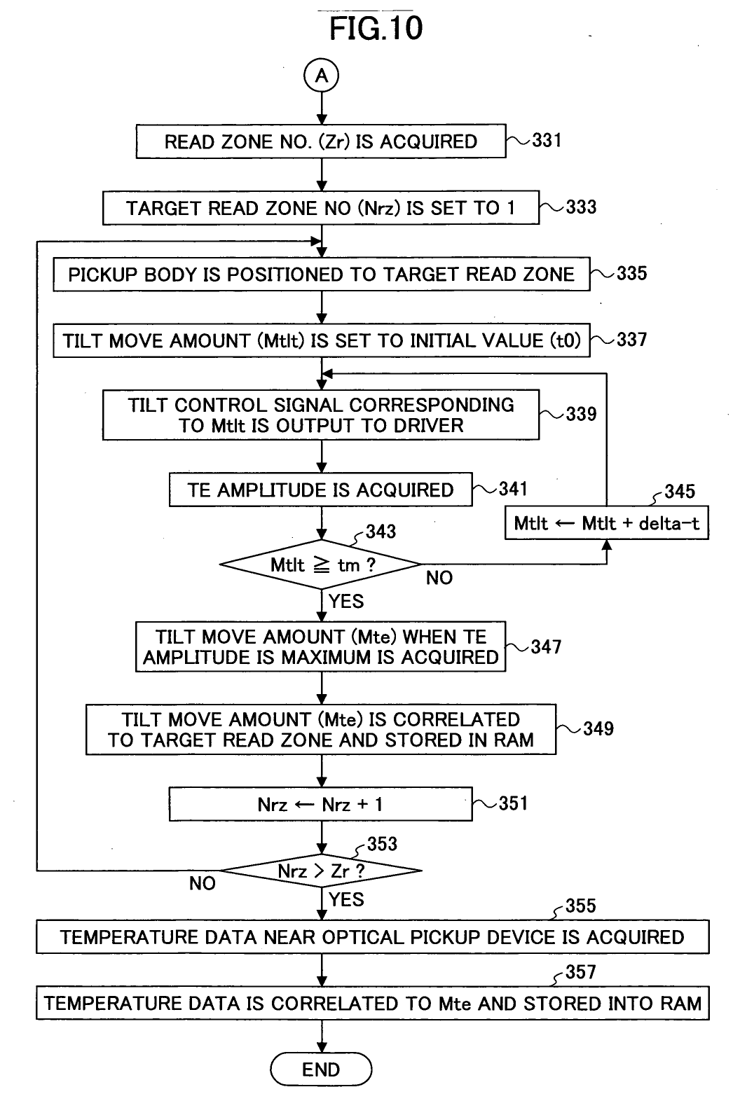

Next, a description will be given of the acquisition processing of the amount of tilt move (called the amount of maximum TE tilt move) when TE amplitude is the maximum mostly for every zone performed when loading of the optical disk 15 is carried out by the optical disk drive 20 with reference to FIG. 9 and FIG. 10. The flowcharts of FIG. 9 and FIG. 10 correspond to a series of the processing algorithms performed by the CPU 40.

If the loading of the optical disk 15 is detected, the start address of the program corresponding to the flowcharts of FIG. 9 and FIG. 10 is set to the program counter of CPU 40, and the acquisition processing of the amount of maximum TE tilt move starts.

At the step 301, the number Zw of write zones is acquired with reference to the track division information stored in the data region of the flash memory 39. Here, it is assumed Zw=6.

At the following step 303, the initialization is performed so that 1 is set to the target write zone number Nwz which indicates the write zone (called the target write zone) as the object of acquisition processing.

At the following step 305, the seeking control signal is outputted so that the pickup main part 101 is located to the predetermined position of the target write zone. For example, the position near the center of the target write zone may be used as the predetermined position at this step. If the pickup main part 101 arrives at the predetermined position, the control shifts to step 307.

At the step 307, the initial value t0 which is predetermined is set to the amount Mtlt of tilt move.

At the following step 309, the tilt control signal corresponding to the amount Mtlt of tilt move is outputted to the driver 27.

At the following step 311, TE amplitude is acquired through the TE amplitude detection unit 28f, and it is correlated with the amount Mtlt of tilt move at this time, and it is stored as write zone TE amplitude information in RAM 41.

At the following step 313, it is determined whether the amount Mtlt of tilt move is larger than the predetermined value tm (>t0). Here, since it is Mtlt=t0, the determination is denied and the control shifts to step 315.

At the step 315, increment delta-t which is predetermined for the amount Mtlt of tilt move is added, and the control returns to the step 309.

Hereafter, the processing of the above steps 309-315 is repeated until the determination at the step 313 is affirmed.

If the amount Mtlt of tilt move is larger than tm, the determination at the step 313 is affirmed, and the control shifts to step 317.

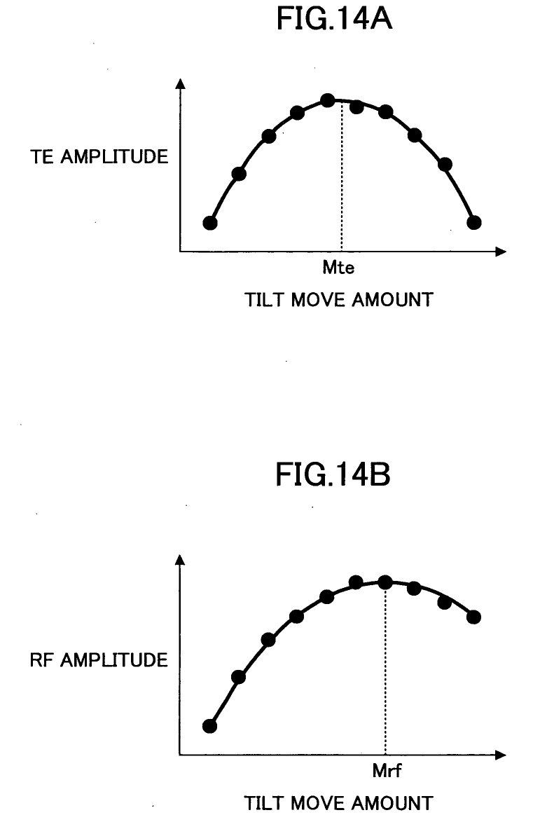

At the step 317, the amount Mte of maximum TE tilt move is calculated based on the write zone TE amplitude information stored in RAM 41. Here, the regression formula indicating the relation between the amount of tilt move and TE amplitude is determined by using the least squares method, and it is possible to determine the amount Mte of maximum TE tilt move based on the regression formula (refer to FIG. 14A).

At the following step 319, the obtained amount Mte of maximum TE tilt move is correlated with the target write zone, and it is stored as the amount information of write zone maximum TE tilt move in RAM 41.

At the following step 321, 1 is added to the target write zone number Nwz, and let the next write zone be the target write zone.

At the following step 323, it is determined whether the target write zone number Nwz is larger than the number Zw of write zones. Here, since it is Nwz=2, the determination is denied and the control returns to the above step 305.

In addition, if Nwz exceeds Zw, the determination at the step 323 is affirmed, and the control shifts to step 331 of FIG. 10. At this time, the number Zw of items of the amount information of write zone maximum TE tilt move is stored in RAM 41.

At the step 331, the number Zr of read zones is acquired with reference to the track division information stored in the data region of the flash memory 39. Here, it is assumed Zr=2.

At the following step 333, the initialization is performed so that 1 is set to the target read zone number Nrz which indicates the read zone (called the target read zone) as the object of acquisition processing.

At the following step 335, the seeking control signal is outputted so that the pickup main part 101 is located to the predetermined position of the target read zone. For example, the position near the center of the target read zone may be used as the predetermined position at this step. If the pickup main part 101 arrives at the predetermined position, the control shifts to step 337.

The initial value t0 is set to the amount Mtlt of tilt move at this step 337.

At the following step 339, the tilt control signal corresponding to the amount Mtlt of tilt move is outputted to the driver 27.

At the following step 341, TE amplitude is acquired through the TE amplitude detection unit 28f, and it is correlated with the amount Mtlt of tilt move at this time, and it is stored as the read zone TE amplitude information in RAM 41.

At the following step 343, it is determined whether the amount Mtlt of tilt move is more than tm. Here, since it is Mtlt=t0, the determination is denied and the control shifts to step 345.

At the step 345, increment delta-t is added to the amount Mtlt of tilt move, and the control returns to the step 339.

Hereafter, the processing of the above steps 339-345 is repeated until the determination at the step 343 is affirmed.

If the amount Mtlt of tilt move is larger than tm, the determination at the step 343 is affirmed, and the control shifts to step 347.

At the step 347, the amount Mte of maximum TE tilt move is calculated, similar to the step 317, based on the read zone TE amplitude information stored in RAM 41.

At the following step 349, the obtained amount Mte of maximum TE tilt move is correlated with the target read zone, and it is stored as the amount information of read zone maximum TE tilt move in RAM 41.

At the following step 351, 1 is added to the target read zone number Nrz, and let the next read zone be the target read zone.

At the following step 353, it is determined whether the target read zone number Nrz is larger than the number Zr of read zones. Here, since it is Nrz=2, the determination is denied and the control returns to the above step 335.

On the other hand, if Nrz is larger than Zr, the determination at the step 353 is affirmed and the control shifts to step 355. In addition, the amount information of read zone maximum TE tilt move on Zr individual will be stored in RAM 41 at this time.

At the step 355, the temperature information near the optical pickup device 23 at this time is detected through the temperature sensor 42.

At the following step 357, the detected temperature information is added to each amount information of write zone maximum TE tilt move, and each amount information of read zone maximum TE tilt move as temperature information when the amount Mte of maximum TE tilt move is obtained, respectively. And the acquisition processing of the amount of maximum TE tilt move is completed.

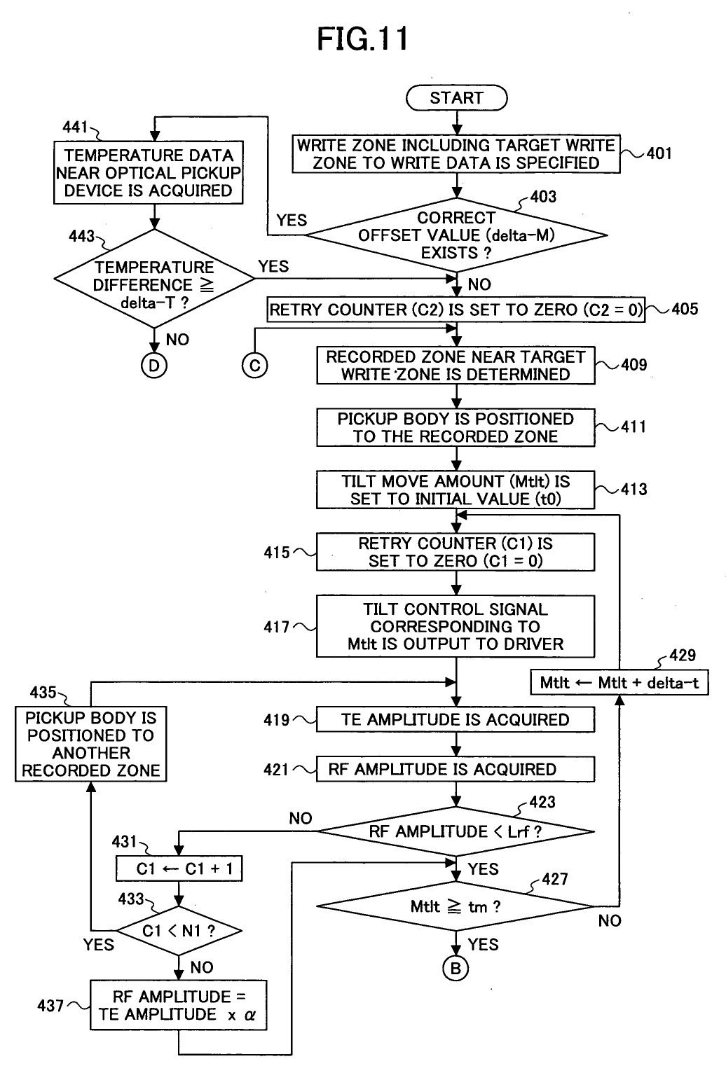

Next, a description will be given of the processing operation performed by the optical disk drive 20 when recording data to the optical disk 15 with reference to FIG. 11 to FIG. 14B.

The flowcharts of FIG. 11 to FIG. 13 correspond to a series of the processing algorithms performed by the CPU 40. If the record request command from the host system is received, the start address of the program corresponding to the flowcharts of FIG. 11-FIG. 13 is set to the program counter of CPU 40, and the processing (called the record request reception processing) will start. In addition, the region (the recording region) where data are recorded is included in one write zone.

At the step 401, the write zone where the region for recording is included is specified with reference to the track division information stored in the flash memory 39.

At the following step 403, it is determined whether the difference (called the compensation offset value) delta-M between the amount of tilt move (called the amount of maximum RF tilt move) in the specified write zone (called the specific write zone) when RF amplitude is the maximum mostly and the amount of maximum TE tilt move is stored in RAM 41. If the compensation offset value delta-M in the specific write zone is not stored in RAM 41, the determination is denied and the control shifts to step 405.

The initial value 0 is set to the re-try counter C2 in which the number of times of acquisition re-try of the optimal amount of tilt move is stored, at this step 405.

At the following step 409, it is located near the region for recording and the region (recorded region) where data are already recorded is determined.

At the following step 411, the seeking control signal is outputted so that the pickup main part 101 may be located in the head position of the recorded region by which the decision is made. If the pickup main part 101 arrives at the head position of the recorded region, the control shifts to step 413.

The initial value t0 is set to the amount Mtlt of tilt move at this step 413.

The initial value 0 is set to the re-try counter C1 in which the number of times of acquisition re-try of TE amplitude and RF amplitude is stored, at the following step 415.

At the following step 417, the tilt control signal corresponding to the amount Mtlt of tilt move is outputted to the driver 27.

At the following step 419, TE amplitude is acquired through the TE amplitude detection unit 28f, and it is correlated with the amount Mtlt of tilt move at this time, and stores it as recorded region TE amplitude information in RAM 41.

At the following step 421, RF amplitude is acquired through the RF amplitude detection unit 28g.

At the following step 423, it is determined whether the acquired RF amplitude is less than the predetermined value Lrf. If the RF amplitude is less than Lrf, it is correlated with the amount Mtlt of tilt move at this time, and stores it in RAM 41 by making RF amplitude into the recorded region RF amplitude information. And the determination is affirmed and the control shifts to step 427.

At this step 427, it is determined whether the amount Mtlt of tilt move is more than tm. Here, since it is Mtlt=t0, the determination is denied and the control shifts to step 429. At this step 429, increment delta-t is added to the amount Mtlt of tilt move, and the control returns to the step 415.

On the other hand, if RF amplitude is larger than Lrf, the determination at the step 423 is denied and the control shifts to step 431. At this step 431, 1 is added to the re-try counter C1.

At the following step 433, it is determined whether the value of the re-try counter C1 is less than the predetermined value N1 (N1 is equal to 2 or more integer). If the value of the re-try counter C1 is less than N1, the determination is affirmed and the control shifts to step 435.

At this step 435, the recorded region other than the recorded region which is determined is set up, and the seeking control signal is outputted so that the pickup main part 101 is located in the head position of this recorded region. If the pickup main part 101 arrives at the head position of this recorded region, the control returns to the step 419. That is, TE amplitude and RF amplitude are canceled and the acquisition re-try of TE amplitude and RF amplitude is performed.

In addition, in the step 433, if the value of the re-try counter C1 is more than N1, it becomes the re-try over, the determination at step 433 is denied, and the control shifts to step 437.

At this step 437, RF amplitude is canceled and set RF amplitude to the value which is calculated by multiplying TE amplitude obtained at the step 419 by a predetermined coefficient alpha obtained by the experiments. And after correlating this RF amplitude with the amount Mtlt of tilt move at this time and it is stored as recorded region RF amplitude information in RAM 41. Then, the control shifts to the step 427.

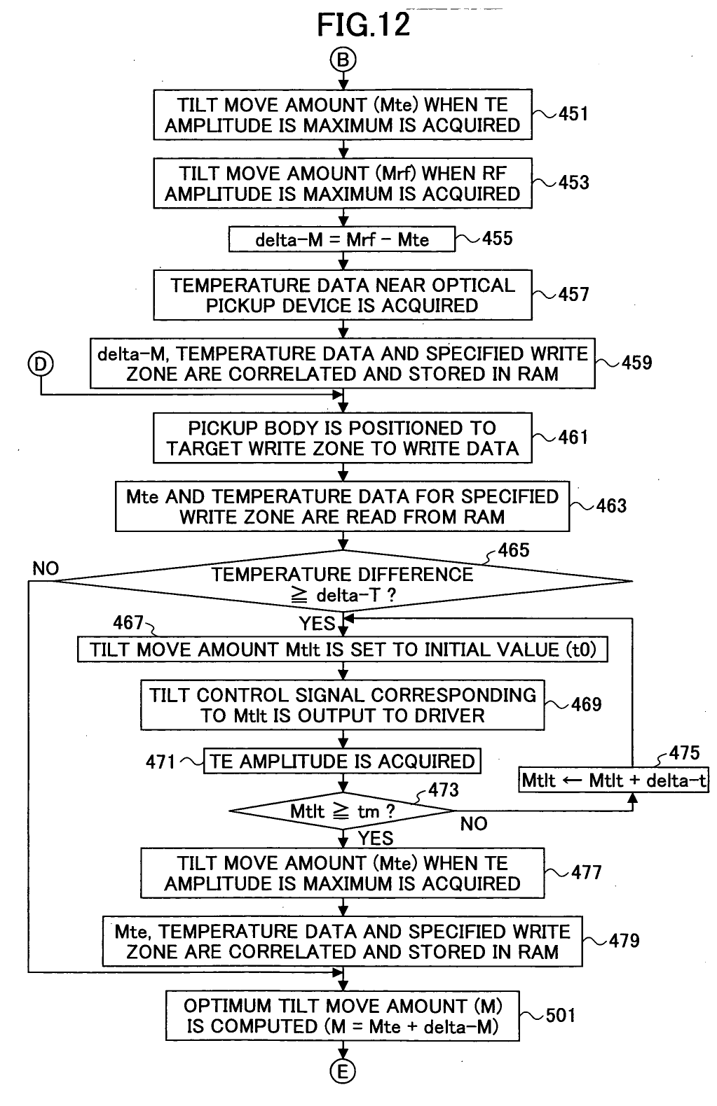

In the step 427, if the amount Mtlt of tilt move is larger than tm, the determination is affirmed and the control shifts to step 451 of FIG. 12.

At this step 451, the amount Mte of maximum TE tilt move is calculated based on the recorded region TE amplitude information stored in RAM 41 (refer to FIG. 14A).

At the following step 453, the amount Mrf of maximum RF tilt move is calculated based on the recorded region RF amplitude information stored in RAM 41 (refer to FIG. 14B).

At the step 455, the compensation offset value delta-M is computed based on the following formula.
delta-M=Mrf−Mte (1)

At the following step 457, the temperature information near the optical pickup device 23 at this time is detected through the temperature sensor 42.

At the following step 459, the temperature information and the specific write zone obtained at the compensation offset value delta-M obtained at the step 455 and the step 457 are associated, respectively, and it is considered as the compensation offset value information, and it is stored in RAM 41.

At the following step 461, the seeking control signal is outputted so that the pickup main part 101 may be located in the head position of the region for record. If the pickup main part 101 arrives at the head position of the region for recording, the control shifts to step 463.

At this step 463, the amount information of write zone maximum TE tilt move in the specific write zone is extracted from among two or more amount information of write zone maximum TE tilt move stored in RAM 41.

At this step 465, it is determined whether the difference between the temperature when the amount Mte of maximum TE tilt move in the specific write zone is obtained and the present temperature is larger than the predetermined value delta-T.

If the difference of temperature is larger than delta-T, the determination is affirmed and the control shifts to step 467.

The initial value t0 is set to the amount Mtlt of tilt move at this step 467.

At the following step 469, the tilt control signal corresponding to the amount Mtlt of tilt move is outputted to the driver 27.

At the following step 471, TE amplitude is acquired through the TE amplitude detection unit 28f, and it is correlated with the amount Mtlt of tilt move at this time, and stores it as specific write zone TE amplitude information in RAM 41.

At the following step 473, it is determined whether the amount Mtlt of tilt move is more than tm. Here, since it is Mtlt=t0, the determination is denied and the control shifts to step 475.

At this step 475, increment delta-t is added to the amount Mtlt of tilt move, and the control returns to the step 467.

Hereafter, the processing of the above steps 467-475 is repeated until the determination at the step 473 is affirmed.

If the amount Mtlt of tilt move is larger than tm, the determination at the step 473 is affirmed, and the control shifts to step 477.

At this step 477, the amount Mte of maximum TE tilt move is calculated based on the specific write zone TE amplitude information stored in RAM 41.

At the following step 479, the temperature information and the specific write zone obtained at the amount Mte of maximum TE tilt move obtained at the step 477 and the step 457 are associated, respectively, and it is considered as the amount information of write zone maximum TE tilt move, and it is stored in RAM 41. Then the control shifts to step 501.

On the other hand, if the difference of temperature is less than the predetermined value in the step 465, the determination at the step 465 is denied and the control shifts to step 501.

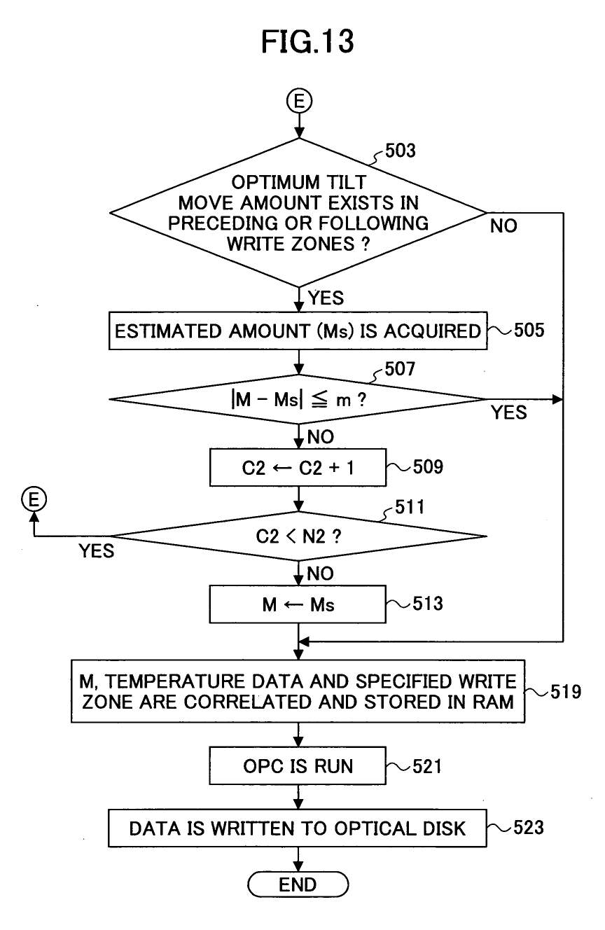

At the step 501, the optimal amount M of tilt move is computed based on the following formulas (2). And the control shifts to step 503 of FIG. 13.
M=Mte+delta-M (2)

At this step 503, it is determined whether the optimal amount of tilt move in the write zone before and after the specific write zone is stored in RAM 41, respectively.

If the optimal amount of tilt move is stored in RAM 41, the determination is affirmed and the control shifts to step 505.

At this step 505, it can set in the write zone before and after the specific write zone each with reference to the optimal amount of tilt move, the estimate delta-Ms of the optimal amount of tilt move in the specific write zone is calculated. Here, as an example, each of the primary interpolation of the optimal amount of tilt move is determined as the estimate delta-Ms.

At the following step 507, it is determined whether the difference between the optimal amount M of tilt move and estimate delta-Ms computed at the step 501 is less than the predetermined value m. That is, it is determined whether the optimal amount M of tilt move computed at the step 501 is valid.

If the above difference is larger than m, the determination is denied and the control shifts to step 509. At this step 509, 1 is added to the re-try counter C2.

At the following step 511, it is determined whether the value of the re-try counter C2 is less than the value N2 (N2 is equal to 2 or greater integer). If the value of the re-try counter C2 is less than N2, the determination is affirmed and the control returns to the above step 409. That is, the acquisition re-try of the optimal amount of tilt move is performed.

On the other hand, if the value of the re-try counter C2 is more than N2, it becomes the re-try over, the determination is denied, and the control shifts to step 513.

At the step 513, the value of estimate delta-Ms is determined as being the optimal amount M of tilt move.

At the following step 519, the optimal amount M of tilt move, the temperature information, and the specific write zone are associated with each other, respectively, and they are stored in RAM 41.

At the following step 521, the OPC (optimum power control) is performed based on the recording speed, so that the optimal recording power is acquired. That is, while the recording power is changed gradually, predetermined data are written to the region (called the PCA (power calibration area) of the optical disk. After this, those data are reproduced from the optical disk sequentially, and the value of the asymmetry detected from the RF signal which mostly agrees with the target value calculated by the experiments is determined as being the highest recording quality, and the recording power corresponding to that value is determined as being the optimal recording power.

At this time, the bottom level (referred to as Lb) of the RF signal in the highest record quality is acquired through the bottom value detection unit 28i, and the peak level (referred to as Lp) of the RF signal in the highest recording quality is acquired through the peak value detection unit 28h, and the beta value is computed based on the following formulas.
Beta=(Lp+Lb)/(Lp−Lb) (3)

Moreover, based on the computed beta value, the desired value (called the target beta value) of the beta value in each write zone is calculated.

At the following step 523, the recording processing of the data from the host system is performed. And when the recording of the data from the host system is completed, the recording request reception processing is done.

In addition, in the step 503, if at least one side of the optimal amount of tilt move in the write zone before and after the specific write zone is not stored in RAM 41, the determination at the step 503 is denied and the control shifts to the step 519. That is, the validity check of the optimal amount M of tilt move is not performed.

Moreover, in the step 507, if the difference is less than m, the optimal amount M of tilt move is valid, the determination at step 507 is affirmed, and the control shifts to the step 519.

Furthermore, in the step 403, if the compensation offset value delta-M of the specific write zone is already stored in RAM 41, the determination at step 403 is affirmed and the control shifts to step 441.

At the step 441, the temperature information near the optical pickup device 23 at this time is detected by using the temperature sensor 42.

At the following step 443, it is determined whether the difference between the temperature when determining the compensation offset value delta-M and the present temperature is larger than delta-T with reference to the compensation offset value information on the specific write zone stored in RAM 41.

If the difference of temperature is larger than delta-T, the determination is affirmed and the control shifts to the step 405. That is, it newly determines compensation offset value delta-M in the specific write zone.

On the other hand, if the difference of temperature is less than the predetermined value, the determination at the step 443 is denied and the control shifts to step 461. That is, the compensation offset value delta-M of the specific write zone stored in RAM 41 is used.

Next, a description will be given of the recording processing of the data in the step 523.

First, the control signal for controlling rotation of the spindle motor 22 is outputted based on record speed to the driver 27, and the message that the record request command is received is notified to the read signal processing circuit 28.

Moreover, the accumulation to the buffer RAM 34 of data which is received from the host system is directed to the buffer manager 37.

If the rotation of the optical disk 15 reaches the predetermined linear velocity, the setting of the servo-on is directed to the servo controller 33. Thereby, the correction of the track deviation and the focal deviation is carried out.

In addition, the compensation of the focal deviation and the track deviation is performed at any time until the recording processing is completed.

The seeking control signal which controls the seeking motor is outputted to the driver 27, so that the optical pickup device 23 is located at the write start point based on the ADIP information outputted from the read signal processing circuit 28 for every predetermined timing.

If the notice that the amount of data of the data accumulated from the buffer manager 37 at the buffer RAM 34 exceeds the predetermined quantity is received, the encoder 25 is requested to create the writing signal.

If the optical pickup device 23 arrives at the writing start point, the tilt control signal corresponding to the optimal amount M of tilt move is outputted to the driver 27. Thereby, the tilt drive current corresponding to the tilt control signal is outputted to the optical pickup device 23 from the driver 27.

The amount of amplitude change of the tracking error signal before and after the output of the tilt control signal is calculated, and if mostly in agreement with the amount of estimated amplitude change presumed from the optimal amount M of tilt move, the writing will be permitted to the encoder 25.

In addition, let the tilt control signal gradually be the tilt control signal corresponding to the optimal amount M of tilt move after judging that tilt control is not performed normally, once outputting the big predetermined tilt control signal to the driver 27 and rotating moving part greatly intentionally, if the amount of amplitude change differs from the amount of estimated amplitude change greatly.

And a check of that the amount of amplitude change is mostly in agreement with the amount of estimated amplitude change permits the writing to the encoder 25.

Thereby, the data from the host are written in the optical disk 15 through the encoder 25, the laser control circuit 24, and the optical pickup device 23.

In addition, during record of data, the beta value is computed based on the output signal of the 28h of the peak value detection units, and the bottom value detection unit 28i, the target beta value corresponding to the specific write zone stored in RAM 41 is compared, and the running OPC which corrects record power based on those differences is performed at any time.

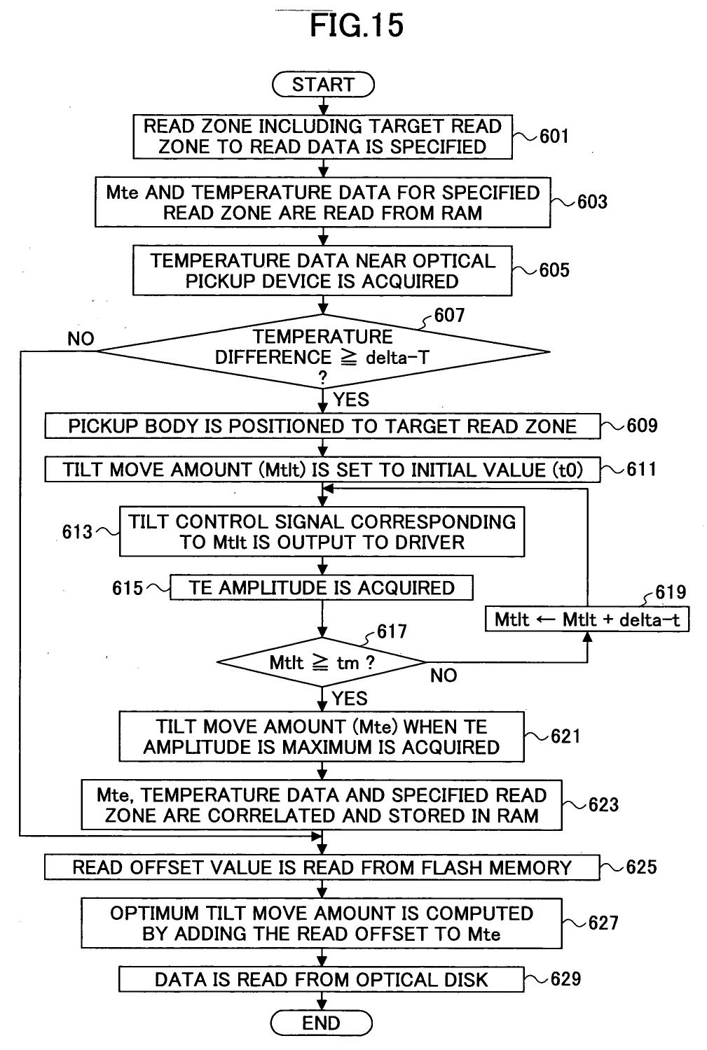

Next, a description will be given of the processing operation performed by the optical disk drive 20 when reproducing the data from the optical disk 15 with reference to FIG. 15.

The flowchart of FIG. 15 corresponds to a series of the processing algorithms performed by the CPU 40. If the reproducing request command from the host system is received, the start address of the program corresponding to the flowchart of FIG. 15 is set to the program counter of CPU 40, and the processing (called the reproduction request reception processing) starts.

In addition, the region (reproducing region) where data are reproduced is included in one read zone.

At the step 601, the read zone where the reproduction region is included is specified with reference to the track division information stored in the flash memory 39. In the following, the read zone specified is called the specific read zone.

At the following step 603, the amount information of read zone maximum TE tilt move in the specific read zone is extracted from among the plurality of items of the amount information of read zone maximum TE tilt move stored in RAM 41.

At the following step 605, the temperature information near the optical pickup device 23 at this time is detected through the temperature sensor 42.

At the following step 607, it is determined whether the difference between the temperature when calculating the amount of maximum TE tilt move in the specific read zone and the present temperature is larger than delta-T. If the difference of temperature is larger than delta-T, the determination is affirmed and the control shifts to step 609.

At the step 609, the seeking control signal is outputted so that the pickup main part 101 is located in the head position of the reproduction region. If the pickup main part 101 arrives at the head position of the reproduction region, the control shifts to step 611. The initial value to is set to the amount Mtlt of tilt move at this step 611.

At the following step 613, the tilt control signal corresponding to the amount Mtlt of tilt move is outputted to the driver 27.

At the following step 615, TE amplitude is acquired through the TE amplitude detection unit 28f, and it is correlated with the amount Mtlt of tilt move at this time, and stored in RAM 41 as the specific read zone TE amplitude information.

At the following step 617, it is determined whether the amount Mtlt of tilt move is larger than tm. Here, since it is Mtlt=t0, the determination is denied and the control shifts to step 619.

At the step 619, increment delta-t is added to the amount Mtlt of tilt move, and the control returns to the step 613.

Hereafter, the processing of the above steps 613 to 619 is repeated until the determination at the step 617 is affirmed.

If the amount Mtlt of tilt move is larger than tm, the determination at the step 617 is affirmed and the control shifts to step 621.

At the step 621, the amount Mte of maximum TE tilt move is calculated based on the specific read zone TE amplitude information stored in RAM 41.

At the following step 623, the temperature information and the specific read zone obtained at the amount Mte of maximum TE tilt move obtained at the step 621 and the step 605 are associated with each other, and it is considered as the amount information of read zone maximum TE tilt move, and stored in RAM 41. Then, the control shifts to step 625.

On the other hand, when it is determined at the step 607 that the difference of temperature is less than delta-T, the determination at the step 607 is denied and the control is transferred to step 625.

At the step 625, the read offset value is read from the flash memory 39.

At the step 627, the optimal amount of tilt move is computed by adding the read offset value to the amount Mte of maximum TE tilt move in the specific read zone.

The reproduction processing of data is performed at the following step 629. And when the reproduction of the data demanded by the host system is completed, the reproduction processing is done.

Next, a description will be given of the reproduction processing of the data in the step 629.

While the control signal for controlling rotation of the spindle motor 22 based on the reproduction speed is outputted to the driver 27, the notice that the reproduction request command is received is sent to the read signal processing circuit 28.

If the rotation of the optical disk 15 reaches the predetermined linear velocity, the setting of the servo on is directed to the servo controller 33. Thereby, the track deviation and the focal deviation are corrected.

In addition, the compensation of the focal deviation and the track deviation is performed at any time until the reproduction processing is completed.

Next, if the optical pickup device 23 is not located in the read-out start point, the seeking control signal is outputted to the driver 27 so that the optical pickup device 23 may be located in the read-out start point based on the ADIP information outputted from the read signal processing circuit 28 for every predetermined timing.

And when the optical pickup device 23 arrives at the read-out start point, the tilt control signal corresponding to the optimal amount of tilt move computed at the step 627 is outputted to the driver 27. Thereby, the tilt drive current according to the tilt control signal is outputted to the optical pickup device 23 from the driver 27.

The amount of amplitude change of the tracking error signal (or RF signal) before and after the output of the tilt control signal is calculated. When the calculated amount of the amplitude change generally accords with the amount of estimated amplitude change which is presumed from the optimal amount of tilt move, the notice of the end of tilt control is sent to the read signal processing circuit 28.

In addition, let the tilt control signal gradually be the tilt control signal corresponding to the optimal amount of tilt move after judging that tilt control is not performed normally, once outputting the predetermined tilt control signal to the driver 27 and rotating moving part greatly intentionally, if the amount of amplitude change differs from the amount of estimated amplitude change greatly.

And a check of that the amount of amplitude change is mostly in agreement with the amount of estimated amplitude change notifies the end of tilt control to the read signal processing circuit 28. Thereby, the data reproduced through 28d of RF signal detection units and decoder 28e are accumulated at the buffer RAM 34.

When the reproduction data are assembled as the sector data, they are transmitted to the host system through the buffer manager 37 and the interface unit 38.

As described in the foregoing, in the optical disk drive of the present embodiment, the control information acquisition unit, the compensation information acquisition unit, the error-processing unit, the invalid processing-unit, the target beta value setting unit, the tilt control unit, the compensation unit, the amplitude change acquisition unit, the storing unit, and the processing unit are realized by using the computer program product embodied to cause the CPU 40 to execute the tilt control method as described above.

Specifically, the control information acquisition unit is realized with the processing of step 501 of FIG. 12. The compensation information acquisition unit is realized with the processing of step 455 of FIG. 12. The error-processing unit is realized with the processing of steps 423, 431, 433, 435 and 437 of FIG. 11. The invalid processing unit is realized with the processing of steps 507, 509, 511 and 513 of FIG. 13. The storing unit is realized with the processing of step 519 of FIG. 13.

In addition, the target beta value setting unit is realized with the processing of step 521 of FIG. 13, and the amplitude change acquisition unit and the processor are realized with the processing of step 523 of FIG. 13 and the processing of step 629 of FIG. 15, respectively.

Moreover, the compensation unit is realized with the processing of step 627 of FIG. 15. The tilt control unit is realized with the processing of step 629 of FIG. 15. However, the present invention is not limited to this embodiment. That is, the above preferred embodiment is good also as constituting a part of each unit realized by the processing which does not pass to an example but follows the program by CPU 40, and at least the processor by hardware, or good also as constituting all by hardware.

Moreover, in the present embodiment, the tilt control program is realized with the program corresponding to the flowcharts shown in FIG. 11-FIG. 13 and FIG. 15 among the programs installed in the program region of the flash memory 39.

Specifically, the control information acquisition step of the tilt control method of the present embodment is carried out with the processing of step 501 of FIG. 12. The compensation information acquisition step is carried out with the processing of step 455 of FIG. 12. The third sub-step is carried out with the processing of step 423 of FIG. 11, and the fourth sub-step is carried out with the processing of steps 431, 433, 435 and 437 of FIG. 11. The determination step is carried out with the processing of step 507 of FIG. 13, and the error-processing step is carried out with the processing of steps 509, 511, and 513 of FIG. 13.

In addition, the target beta value setting step is carried out with the processing of step 521 of FIG. 13. Moreover, the tilt control step is carried out with the processing of steps 627 and 629 of FIG. 15. Furthermore, the amplitude change acquisition step is carried out with the processing of step 523 of FIG. 13, and the processing of step 629 of FIG. 15, respectively.

According to the optical disk drive of the present embodiment as described above, if the recording request command is received from the host system, based on the compensation offset value which indicates the difference between the amount of maximum RF tilt move and the amount of maximum TE tilt move in the recorded region of the optical disk (compensation information), and based on the amount of maximum TE tilt move in the region for recording, the optimal amount of tilt move for controlling inclination of the objective lens (tilt control information) is calculated, and the tilt control is carried out by the tilt control signal which is created based on the optimal amount of tilt move.

It is possible to suppress the wave aberration in the optical spot formed in the recording region of the optical disk through the objective lens more effectively than the case where the tilt control is performed using the tilt control signal which is created only based on the amount of maximum TE tilt move in the recording region. Therefore, it is possible to increase the recording quality. Moreover, the optimal amount of tilt move can be acquired in a short time.

Therefore, the inclination of the objective lens to the optical disk can be controlled with sufficient precision, without causing the fall of performance as a result.

Moreover, according to the present embodiment, at the time of recording, since the compensation offset value is calculated in the recorded region near the region for recording, the tilt control signal with small error can be created.

Moreover, according to the present embodiment, when loading of the optical disk is carried out, in the write zone (region for record control) and the read zone (region for reproduction control), the amount of maximum TE tilt move is acquired for every zone, respectively, and it is stored with the temperature information at that time in RAM 41. It is possible to calculate the optimal amount of tilt move, without newly acquiring the amount of maximum TE tilt move, at the time of recording and reproduction, when the temperature change is small. Namely, the tilt control can be performed with sufficient precision, without reducing performance in response to the recording request or the reproduction request sent from the host system.

Moreover, according to the present embodiment, in the cases of recording and reproduction, when the difference between the temperature at that time and the temperature when calculating the amount of maximum TE tilt move and being stored in RAM is large, a new amount of maximum TE tilt move is acquired without using the amount of maximum TE tilt move stored in RAM. Even if it is the case where the emission power of the semiconductor laser is large and the influence of the temperature change to the tilt cannot be disregarded, the tilt control can be performed with sufficient precision.

Moreover, according to the present embodiment, since the target beta value is set up for every write zone, the error resulting from the tilt difference between the write zones in Running OPC is suppressed, and the optimal luminescence power can be maintained. That is, it is possible to maintain good recording quality.

Moreover, the performance to the reproduction request from the host system can be raised, performing tilt control of the required precision according to the present embodiment, since the number of read zones is set up few compared with the number of write zones.

Moreover, according to the present embodiment, at the time of reproduction, since the tilt control signal is created in consideration of the difference of the optimal inclination of the objective lens at the time of reproduction, and the optimal inclination of the objective lens at the time of record, tilt control can be performed with sufficient precision.

Moreover, since TE amplitude and RF amplitude at that time are canceled and the acquisition re-try of TE amplitude and RF amplitude is performed in another recorded region, when acquired RF amplitude is beyond the predetermined value according to the present embodiment, for example, even if it is near the boundary of the recorded region and the non-recorded region, the high compensation offset value of precision can be calculated.

And if it becomes the re-try over, since the value which multiplied TE amplitude by the predetermined coefficient is made into RF amplitude, the fall of performance can be suppressed.

Moreover, since the acquired compensation offset value is stored with the predetermined information at RAM according to the present embodiment, it is not necessary to newly perform processing which acquires the compensation offset value at the time of the same conditions, and performance can be raised.

Moreover, since according to the present embodiment it is determined whether the optimal amount of tilt move acquired in the specific write zone is valid based on the optimal known amount of tilt move in the write zone before and after the specific write zone, and the acquisition re-try of the optimal amount of tilt move is performed when it is invalid, it becomes possible to eliminate the measurement error by the sudden situation, and the optimal amount of tilt move with the high precision can be calculated. And if it becomes the re-try over, since the optimal amount of tilt move in the specific write zone will be presumed based on the optimal known amount of tilt move, the fall of performance can be suppressed.

Moreover, according to the present embodiment, since the optimal tilt controlled variable is calculated using the amount near the central part of the read zone of maximum TE tilt move, it is possible to perform the tilt control with the precision required for a shorter time than before.

Moreover, according to the present embodiment, since inclination of the objective lens is corrected with sufficient precision in advance of record and reproduction of data, it becomes possible to be stabilized and to perform access to the optical disk excellent in the response.

Moreover, according to the present embodiment, the amount of amplitude change of the tracking error signal before and after the output of the tilt control signal is calculated at the time of record, and it compares with the amount of estimated amplitude change presumed from the optimal amount of tilt move. Thereby, it can be checked whether tilt control has been performed correctly.

Moreover, according to the present embodiment, the amount of amplitude change of the tracking error signal before and after the output of the tilt control signal or RF signal is calculated at the time of reproduction, and it compares with the amount of estimated amplitude change presumed from the optimal amount of tilt move. Thereby, it can be checked whether tilt control has been performed correctly.

In addition, although the above preferred embodiment explained the case where the region for record is included in one write zone, it is possible to straddle not only this but two or more write zones. In this case, two or more specific write zones exist and the optimal tilt controlled variable is computed for every specific write zone.

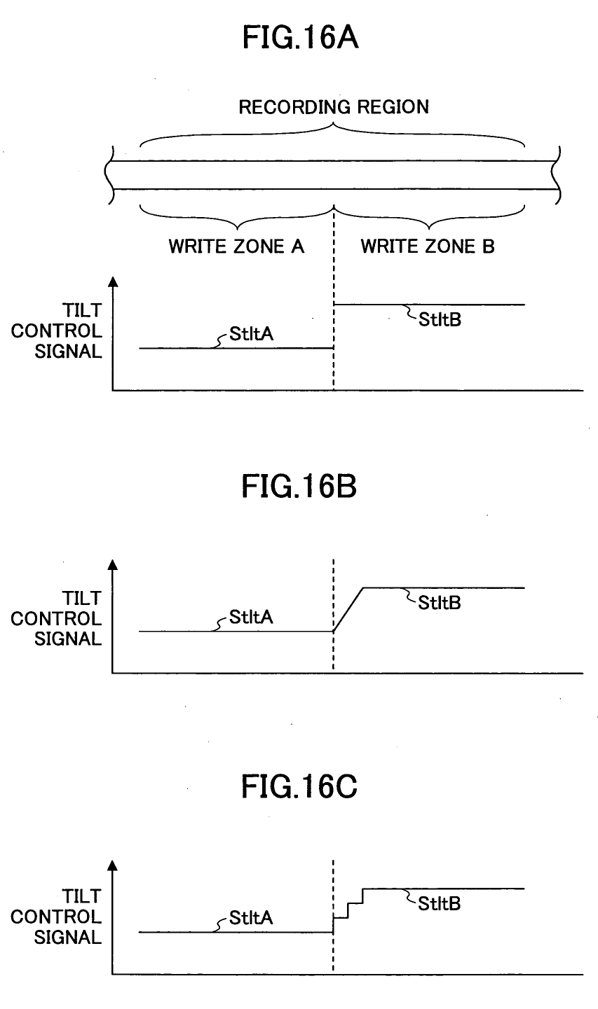

As shown in FIG. 16A, when the recording region is overlapped over the write zone A and the write zone B, the optimal tilt controlled variable (referred to as MtltA) in the write zone A and the optimal tilt controlled variable (referred to as MtltB) in the write zone B are computed and recorded on the write zone A.

In case the tilt control signal StltA corresponding to the tilt controlled variable MtltA is outputted to the driver and records on the write zone B, the driver output of the tilt control signal StltB corresponding to the tilt controlled variable MtltB is carried out.

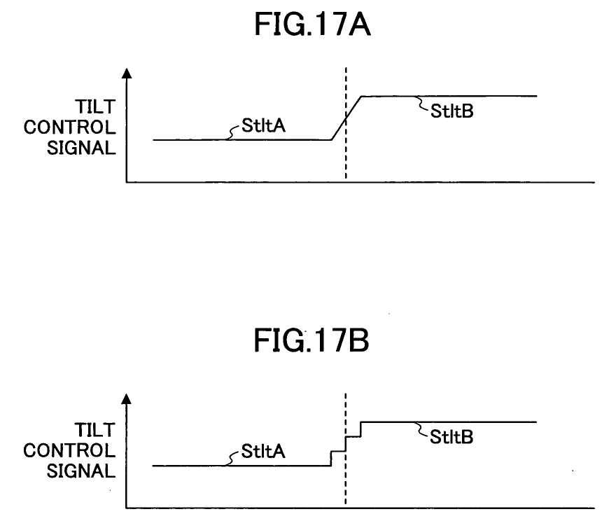

In addition, when the difference of the tilt controlled variable MtltA and the tilt controlled variable MtltB is beyond the predetermined value, as shown in FIG. 16B, FIG. 16C, FIG. 17A, and FIG. 17B, it is possible to change the tilt control signal from StltA to StltB gradually. Thereby, even if the write zone switches, the optimal record power can be maintained.

Furthermore, in the above preferred embodiment, it sets to record processing of data, and is the optical pickup device. Although the case where the tilt control signal is outputted to the driver 27 is explained when 23 wrote in and it arrived at the start point, when not only this but the optical pickup device 23 writes in and it reaches near the start point, it is possible to output the tilt control signal to the driver 27.

In this case, it originates in rotation of the lens holder by inertia power when the seeking motor stops, and the amount of tilt move may not correspond to the tilt control signal.

Then, when those differences are beyond predetermined values, after determining TE amplitude before and after the stop of the seeking motor, and outputting the once big tilt control signal to the driver, it is possible to make it the predetermined tilt control signal gradually. Therefore, the tilt control can be performed with sufficient precision.

Similarly, in the reproduction processing also, when similarly the optical pickup device 23 reaches near the read start point, it is possible to output the tilt control signal to the driver 27.

Also in this case, when those differences are beyond predetermined values, after determining TE amplitude or RF amplitude before and after the stop of the seeking motor, and outputting the large tilt control signal to the driver, it is possible to make it the predetermined tilt control signal gradually. Therefore, the tilt control can be performed with sufficient precision.

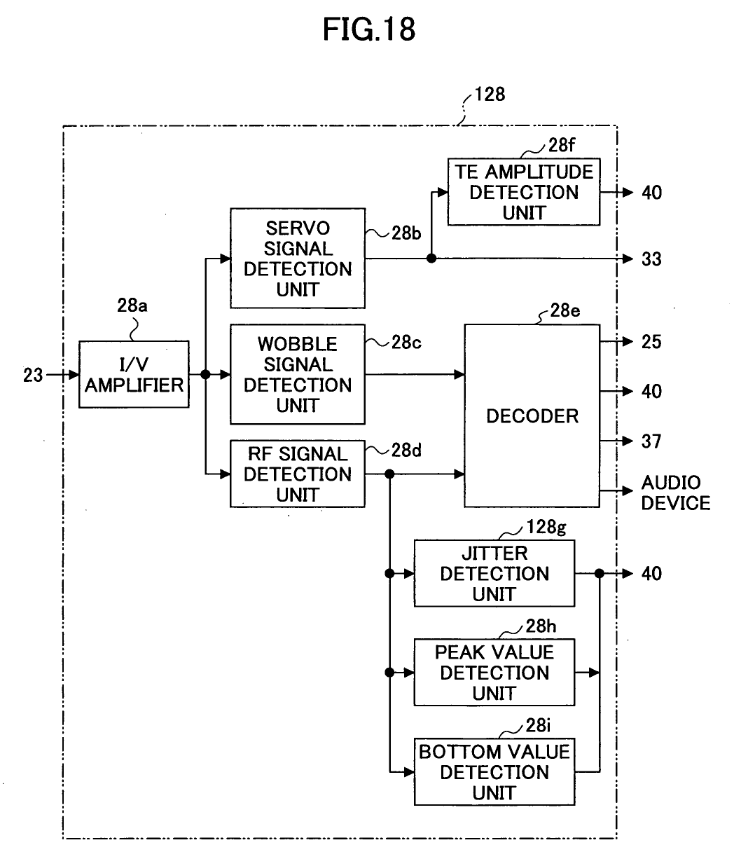

Moreover, in the preferred embodiment, the jitter may be used instead of the RF amplitude. FIG. 18 shows the read signal processing circuit 128 when the jitter is used instead of the RF amplitude. As shown in FIG. 18, in the read signal processing circuit 128, instead of the RF amplitude detection unit 28g, the jitter detection unit 128g is provided to detect the jitter based on the RF signal detected by the RF signal detection unit 28d.

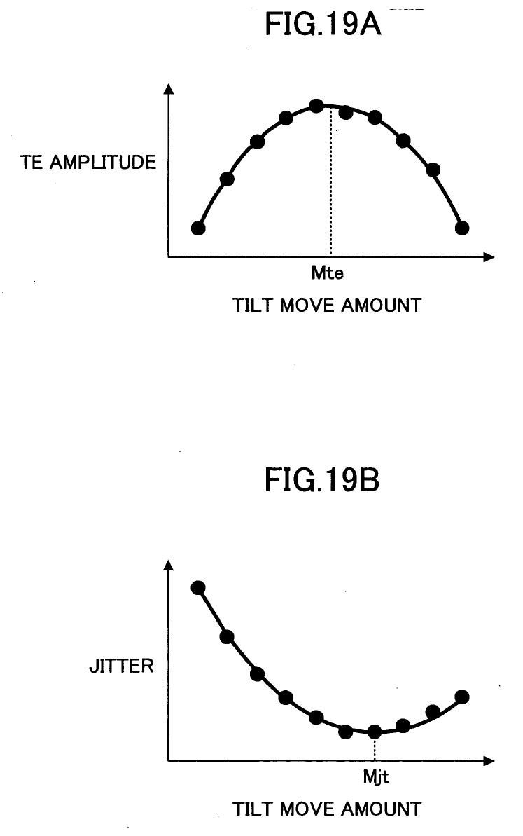

As shown in FIG. 19A and FIG. 19B, the amount Mjt of tilt move in case the jitter serves as the minimum is used instead of the amount Mrf of maximum RF tilt move.

Moreover, in the preferred embodiment, when changing RF amplitude sharply by the zone, it is possible to change the property of RF equalizer (not shown) which constitutes the RF signal detection unit 28d for every zone so that RF amplitude of 3T may become almost the same in every zone. This becomes possible to calculate the amount of maximum RF tilt move with still more sufficient precision.

Moreover, when the difference with the temperature when determining the temperature at that time on the occasion of record and reproduction, and calculating the amount of maximum TE tilt move stored at RA M in the preferred embodiment is large. Although the case where the amount of maximum TE tilt move is newly calculated is explained without using the amount of maximum TE tilt move stored at RAM.

It is possible to use the amount of maximum TE tilt move stored at RAM, without performing the temperature check, when it is clear like in case record processing is not performed once that the difference of temperature is not so large, after loading not only of this but the optical disk is carried out.

Moreover, when the addition time which made the semiconductor laser emit light by record power exceeds predetermined time, it is possible to newly calculate the amount of maximum TE tilt move.

Moreover, in the above preferred embodiment, when two or more amounts of maximum TE tilt move obtained at the time of the mutually different temperature are stored in RAM 41, it determines the temperature at that time in the case of record and reproduction, and the amount of maximum TE tilt move obtained at the time of the temperature near the temperature may be extracted from RAM 41, and the optimal amount of tilt move may be calculated using the amount of maximum TE tilt move.

The data acquired in the past can be utilized effectively by this, and it becomes possible to raise the performance of record and reproduction.

Moreover, in the above preferred embodiment, when two or more compensation offset values acquired at the time of the mutually different temperature are stored in RAM 41, it determines the temperature at that time in the case of record, and the compensation offset value acquired at the time of the temperature near the temperature may be extracted from RA M41, and the optimal amount of tilt move may be calculated using the compensation offset value. The data acquired in the past can be utilized effectively by this, and it becomes possible to raise the performance of record.

Moreover, in the preferred embodiment, when two or more optimal amounts of tilt move obtained at the time of the mutually different temperature are stored in RAM 41, it may determine the temperature at that time in the case of record and reproduction, the optimal amount of tilt move obtained at the time of the temperature near the temperature may be extracted from RAM 41, and it is possible to create the tilt control signal according to the optimal amount of tilt move. The data acquired in the past can be utilized effectively by this, and it becomes possible to raise the performance of record further.

Moreover, in the preferred embodiment, the step 505 is performed so that the estimated Ms is determined from the primary interpolation of each optimal amount of tilt move. However, the present invention is not limited to this and the estimated Ms may be calculated using the methods other than the primary interpolation.

Moreover, although the preferred embodiment explained the case where the optimal amount of tilt move of the specific write zone is presumed, based on the optimal amount of tilt move of the write zone located before and after the specific write zone, it is not limited to this and the estimated Ms may be calculated based on the optimal amount of tilt move of the write zone located in either before and after the specific write zone.

Moreover, although the preferred embodiment explained the case where the number of write zones is 6, it is not limited to this. According to the situation in the optical disk of curving, it is possible to change the number of write zones.

Moreover, what is necessary is just to set up also about the size of each write zone according to the situation in the optical disk of curving. Moreover, it is possible to have the division information at the time of record for every vender of the optical disk.

Moreover, although the preferred embodiment explained the case where the number of read zones is 2, it is not limited to this. In short, the tilt control should just be made to the grade which can obtain normal reproduction data, without reducing the performance of reproduction processing not much.

Moreover, what is necessary is just to set up also about the size of each read zone, according to the situation in the optical disk of curving so that tilt control can be performed efficiently. Moreover, it is possible to have the division information at the time of reproduction for every vender of the optical disk.

Moreover, in the above preferred embodiment, when it can be expected that the grade to shave is about 1 appearance small, it is good also considering the number of read zones as 1. In this case, it is possible to calculate the amount of maximum TE tilt move near the central part of the read zone. This becomes possible to suppress very low the fall of the performance of the reproduction processing by tilt control.

Moreover, although the preferred embodiment explained the case where the recording power is corrected in running OPC based on the difference of the beta value and target beta value which are computed, the desired value (target B value) of B value is predetermined for every write zone, and the recording power may be corrected in running OPC based on the difference of the B value and the target B value which is detected.

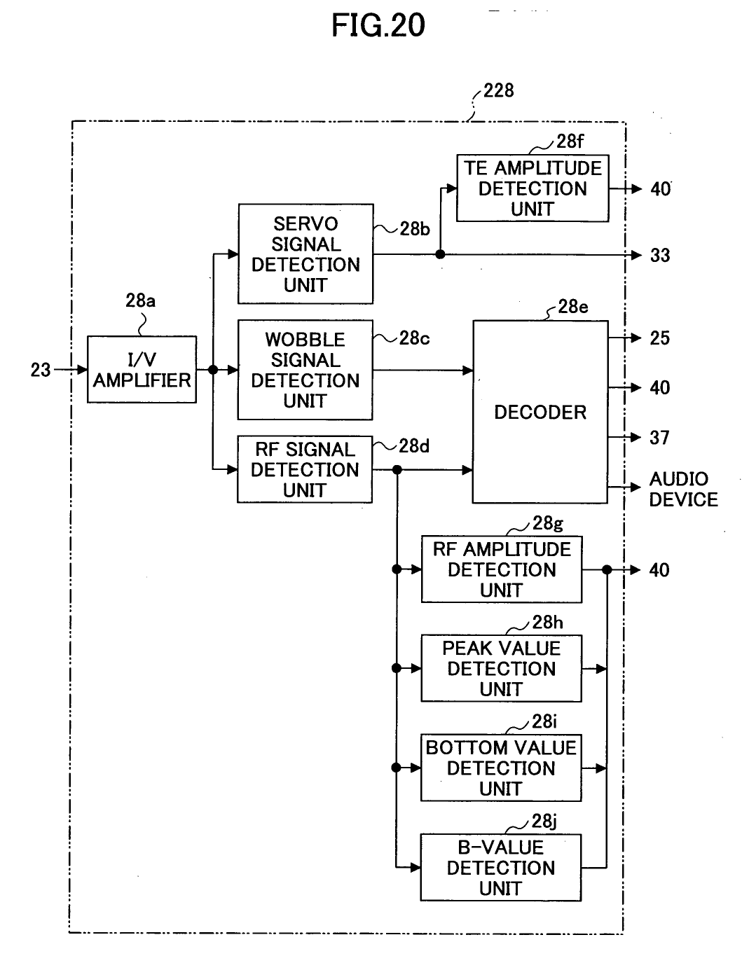

In such alternative embodiment, the read signal processing circuit 228 may be configured as shown in FIG. 20 so that the B-value detection unit 28j is provided to detect the B-value based on the RF signal detected by the RF signal detection unit 28d.

Moreover, although the above preferred embodiment explained the case where trial writing is performed to PCA, in OPC, when the writing is made at random, for example like DVD+RW, it is possible to perform OPC for every write zone. While being able to obtain the optimal record power with the thereby still more sufficient precision, in Running OPC, it becomes possible to correct record power with sufficient precision.

Moreover, although the above preferred embodiment explained the case where the optimal amount of tilt move is calculated regardless of record speed, when the range of the possible record speed is wide, it is possible to calculate the optimal amount of tilt move for every record speed. Moreover, when record speed is the low speed, for example, it is possible to calculate the respectively optimal amount of tilt move in the high-speed time.

Moreover, although the case where acquisition processing of the amount of maximum TE tilt move for every zone is performed, respectively is explained in the write zone and the read zone by the above preferred embodiment when loading of the optical disk is carried out, only in either not only of this but for example, write zones and read zones, acquisition processing of the amount of maximum TE tilt move for every zone may be performed. Moreover, when loading of the optical disk is carried out, acquisition processing of the amount of maximum TE tilt move for every zone does not need to be performed. And what is necessary is just to ask then, if the amount of maximum TE tilt move of the specific write zone is not stored in RAM 41 at the time of record.

What is necessary is similarly, just to ask then, if the amount of maximum TE tilt move of the specific read zone is not stored in RAM 41 at the time of reproduction.

Moreover, in the preferred embodiment, when the RF amplitude acquired at step 421 is larger than Lrf, TE amplitude and RF amplitude in another recorded region are determined until it becomes the re-try over. However, the present invention is not limited to this embodiment, and when the RF amplitude is larger than Lrf, it is possible to shift to step 437 immediately, without carrying out re-try. Namely, the steps 431, 433 and 435 may be omitted.

Moreover, in the preferred embodiment, when the optimal amount of tilt move acquired in the specific write zone is invalid, the acquisition re-try of the optimal amount of tilt move is performed until it becomes the re-try over. However, the present invention is not limited to this embodiment, and after it is determined that it is invalid, it is possible to shift to step 513, without carrying out re-try. That is, the steps 509 and 511 may be omitted.

Moreover, although the above preferred embodiment explained the case where the compensation offset value is used, as compensation information, it is not limited to this. What is necessary is just the compensation information which becomes settled with two or more kinds of signals acquired when the recorded region is reproduced.

In addition, in the above preferred embodiment, when the variation in TE amplitude detected when calculating the amount of maximum TE tilt move in the region for record is large, it is possible to correct TE amplitude detected in the region for record using the ratio of TE amplitude before and after record in the recorded region near the region for record. Thereby, the amount of maximum TE tilt move can be calculated with sufficient precision.

Moreover, although the above preferred embodiment explained the case where the objective lens 60 is rotated in the X Z side using the two coils for the tilts, it is not limited to this.

Moreover, the two coils for the tracking are used in the above preferred embodiment, and it is the objective lens 6. Although the case where 0 is driven to the tracking direction is explained, it is not limited to this.

Moreover, although the above preferred embodiment explained the case where the objective lens 60 is driven in the direction of the focus using the one coil for the focusing, it is not limited to this.

Moreover, although the above preferred embodiment explained the case where the inclination (radial tilt) of the objective lens to the direction (radial direction) which intersects perpendicularly in the direction of the tangent of the track of the optical disk is corrected, the present invention can be applied when correcting the inclination (tangential tilt) of the objective lens to the direction of the tangent of the track of the optical disk (tangential direction). In this case, the objective lens will be rotated in YZ side.

Moreover, in the above preferred embodiment, although the tilt control program is recorded on the flash memory 39, it may be recorded on other recording mediums (CD system optical disk, the DVD system optical disk, the magneto-optic disk, the memory card, flexible disk, etc.). In this case, the drive device corresponding to the recording medium will be added, and the tilt control program will be transmitted to the flash memory 39 from the drive device. Moreover, it is possible to transmit the tilt control program to the flash memory 39 through the networks (LAN, intranet, Internet, etc.).

Moreover, although the above preferred embodiment explained the case where moving part is rotated to the circumference of the guide shaft, as a drive for correcting the tilt, the present invention is not limited to this.

Moreover, although the above preferred embodiment explained the case where it corresponded to the optical disk with which the optical disk drive is based on the specification of the DVD system, it is possible to be the optical disk drive corresponding to the optical disk with which the present invention is not limited to this and based on the specification of CD system. Furthermore, it is possible to be the optical disk drive corresponding to two or more kinds of optical disks based on mutually different specification. In this case, the wavelength may be the optical disk drive corresponding to the optical disk which are about 405 nm, about 650 nm, and about 780 nm and with which one of the laser beams is used at least.

Moreover, although the above preferred embodiment explained the case where the optical pickup device is equipped with the one semiconductor laser, it is possible to have two or more semiconductor laser which emits light in the light beam of not only this but the wavelength which is mutually different, for example. In this case, the semiconductor laser and wavelength which emit light in the semiconductor laser which emits light in the light beam whose wavelength is 405 nm, for example, and the light beam whose wavelength is 660 nm may contain at least one of the semiconductor laser which emits light in the light beam which is 780 nm.

Moreover, although the preferred embodiment explained the case where the interface unit 38 is based on the specification of ATAPI, it may be based on the specifications of either not only of this but ATA (AT attachment), SCSI (small computer system interface), USB (universal serial bus) 1.0, USB 2.0, IEEE1394, IEEE802.3, serial ATA, and serial ATAPI.

The present invention is not limited to the above-described embodiments, and variations and modifications may be made without departing from the scope of the present invention.

Further, the present application is based on Japanese priority application No. 2003-133125, filed on May 12, 2003, the entire contents of which are hereby incorporated by reference.

1. A tilt control method which controls an inclination of an objective lens to an optical disk in which a track in the shape of a spiral or a concentric circle is formed, the tilt control method comprising steps of:
recording data to the optical disk; and
acquiring, when recording the data to the optical disk, tilt control information for controlling the inclination of the objective lens based on both known compensation information that is defined with a plurality of kinds of signals acquired when reproducing data from a recorded region of the optical disk, and information that is related to an inclination of the objective lens when an amplitude of a tracking error signal is substantially a maximum in a recording region of the optical disk where the data are recorded.

2. The tilt control method according to claim 1 wherein the recorded region is a recorded region of the optical disk which is located near the recording region of the optical disk.

3. The tilt control method according to claim 1 wherein the known compensation information is information related to a difference between an inclination of the objective lens when the amplitude of the tracking error signal is substantially a maximum in the recorded region and an inclination of the objective lens when an amplitude of an RF signal is substantially a maximum in the recorded region or an jitter is substantially an minimum in the recorded region.

4. The tilt control method according to claim 3 further comprising a step of acquiring the known compensation information prior to the step of acquiring the tilt control information.

5. The tilt control method according to claim 4 wherein the step of acquiring the known compensation information comprises sub-steps of:
acquiring first inclination information related to the inclination of the objective lens when the amplitude of the tracking error signal is substantially the maximum in the recorded region, and second inclination information related to the inclination of the objective lens when the amplitude of the RF signal is substantially the maximum in the recorded region or the jitter is substantially the minimum in the recorded region; and
acquiring the known compensation information based on the first inclination information and the second inclination information.

6. The tilt control method according to claim 5 wherein the step of acquiring the known compensation information further comprises sub-steps of:
determining, prior to the sub-step of acquiring the known compensation information, whether the acquired second inclination information is valid; and
performing an error processing when it is determined that the acquired second inclination information is invalid.

7. The tilt control method according to claim 6 wherein, in the determination sub-step, when the inclination of the objective lens with the amplitude of the RF signal being substantially the maximum in the recorded region or the jitter being substantially the minimum in the recorded region is less than a predetermined value, it is determined that the acquired second inclination information is valid.

8. The tilt control method according to claim 6 wherein, in the error-processing sub-step, the first inclination information and the second inclination information are canceled, and new first inclination information related to an inclination of the objective lens when the amplitude of the tracking error signal is substantially a maximum in a new recorded region of the optical disk different from said recorded region, and new second inclination information related to an inclination of the objective lens when the amplitude of the RF signal is substantially the maximum in the new recorded region or the jitter is substantially the minimum in the new recorded region are acquired.

9. The tilt control method according to claim 6 wherein, in the error-processing sub-step, the second inclination information is canceled, and new second inclination information is aquired by determining a value of multiplication of the inclination of the objective lens when the amplitude of the tracking error signal is substantially the maximum in the recorded region and a predetermined coefficient as being the inclination of the objective lens when the amplitude of the RF signal is substantially the maximum in the recorded region or the jitter is substantially the minimum in the recorded region.

10. The tilt control method according to claim 1 wherein the tilt control information is acquired for each of recording speeds of an optical disk drive.

11. The tilt control method according to claim 1 further comprising a step of acquiring, prior to the step of acquiring the tilt control information, a relation between the amplitude of the tracking error signal in the recording region and the inclination of the objective lens, and in the step of aquiring the relation, the amplitude of the tracking error signal in the recording region is corrected using a ratio of amplitudes of the tracking error signal before and after recording the data in the recorded region.

12. The tilt control method according to claim 1 wherein the track of the optical disk is divided into a plurality of write regions for tilt control at the time of recording, and the tilt control information is aquired for each of the plurality of write regions.

13. The tilt control method according to claim 12 further comprising steps of:
determining whether the tilt control information acquired in the tilt control information acquiring step for a specific write region among the plurality of write regions in which the recording region is included is valid, based on each of the tilt control information acquired for two of the plurality of write regions located before and after the specific write region; and
canceling the tilt control information acquired in the tilt control information acquiring step to perform an error processing when it is determined in the determining step that the tilt control information is invalid.

14. The tilt control method according to claim 13 wherein, in the determining step, a criterion is determined based on each of the tilt control information acquired for the two of the plurality of write regions located before and after the specific write region, and it is determined that the tilt control information acquired in the tilt control information acquiring step is valid, when the tilt control information acquired in the tilt control information acquiring step meets the criterion.

15. The tilt control method according to claim 13 wherein, in the error processing, the tilt control information for the specific write region is estimated based on each of the tilt control information acquired for the two of the plurality of write regions located before and after the specific write region, and the estimated tilt control information is determined as being the tilt control information for the specific write region.

16. The tilt control method according to claim 13 wherein, in the error processing, the tilt control information acquiring step is repeated so that the tilt control information is acquired again.

17. The tilt control method according to claim 12 wherein, when the recording region is overlapped over a first write region and a second write region among the plurality of write regions and a data writing position changes from the first write region to the second write region during recording of the data, the tilt control method further comprises a step of adjusting the inclination of the objective lens so that the inclination of the objective lens changes gradually near a boundary of the first write region and the second write region.

18. The tilt control method according to claim 12 further comprising a step of setting a desired value of a beta value for each of the plurality of write regions, based on results of recording and reproduction of predetermined data to and from a power calibration area of the optical disk.

19. The tilt control method according to claim 12 further comprising a step of setting a descired value of a B value for each of the plurality of write regions, based on results of recording and reproduction of predetermined data to and from a power calibration area of the optical disk.

20. The tilt control method according to claim 1 further comprising steps of:
reproducing the data from the optical disk; and
controlling, when reproducing the data from the optical disk, the inclination of the objective lens based on tilt control information acquired near a central part of the track of the optical disk.

21. The tilt control method according to claim 12 wherein the track of the optical disk is divided into a plurality of read regions for tilt control at the time of reproducing, the tilte control method further comprising steps of:
reproducing the data from the optical disk; and
controlling, when reproducing the data from the optical disk, the inclination of the objective lens based on tilt control information acquired near a central part of a specific read region among the plurality of read regions in which a reproducing region where the data is reproduced is included.

22. The tilt control method according to claim 21 wherein the number of the read regions is smaller than the number of the write regions.

23. The tilt control method according to claim 20 wherein, in the step of controlling the inclination of the objective lens, the tilt control information acquired near the central part of the track of the optical disk is corrected based on known information related to a difference between an optimal inclination of the objective lens at the time of recording and an optimal inclination of the objective lens at the time of reproduction.

24. A tilt control method which controls an inclination of an objective lens to an optical disk in which a track in the shape of a spiral or a concentric circle is formed, the tilt control method comprising steps of:
reproducing data from the optical disk; and
controlling, when reproducing the data from the optical disk, the inclination of the objective lens based on tilt control information acquired near a central part of the track of the optical disk.

25. The tilt control method according to claim 24 wherein the tilt control information is acquired for each of temperatures near the objective lens.

26. The tilt control method according to claim 25 further comprising a step of acquiring information related to an amplitude change of a tracking error signal or an RF signal before and after controlling the inclination of the objective lens.

27. The tilt control method according to claim 26 further comprising a step of detecting whether there is an amplitude change of the tracking error signal or the RF signal before and after a stop of movement of the objective lens when the objective lens is moved in a seeking operation.

28. A computer program product embodied therein to cause a computer of an optical disk drive to execute a tilt control method which controls an inclination of an objective lens to an optical disk in which a track in the shape of a spiral or a concentric circle is formed, the method comprising steps of:
recording data to the optical disk;
acquiring, when recording the data to the optical disk, known compensation information that is defined with a plurality of kinds of signals acquired when reproducing data from a recorded region of the optical disk; and
acquiring tilt control information for controlling the inclination of the objective lens based on both the known compensation information and information that is related to an inclination of the objective lens when an amplitude of a tracking error signal is substantially a maximum in a recording region of the optical disk where the data are recorded.

29. The computer program product according to claim 28 wherein the step of acquiring the known compensation information comprises sub-steps of:
acquiring first inclination information related to the inclination of the objective lens when the amplitude of the tracking error signal is substantially the maximum in the recorded region, and second inclination information related to the inclination of the objective lens when the amplitude of the RF signal is substantially the maximum in the recorded region or the jitter is substantially the minimum in the recorded region; and
acquiring the known compensation information based on the first inclination information and the second inclination information.

30. The computer program product according to claim 29 wherein the step of acquiring the known compensation information further comprises sub-steps of:
determining, prior to the sub-step of acquiring the known compensation information, whether the acquired second inclination information is valid; and
performing an error processing when it is determined that the acquired second inclination information is invalid.

31. The computer program product according to claim 30 wherein, in the error-processing sub-step, the first inclination information and the second inclination information are canceled, and new first inclination information related to an inclination of the objective lens when the amplitude of the tracking error signal is substantially a maximum in a new recorded region of the optical disk different from said recorded region, and new second inclination information related to an inclination of the objective lens when the amplitude of the RF signal is substantially the maximum in the new recorded region or the jitter is substantially the minimum in the new recorded region are acquired.

32. The computer program product according to claim 30 wherein, in the error-processing sub-step, the second inclination information is canceled, and new second inclination information is aquired by determining a value of multiplication of the inclination of the objective lens when the amplitude of the tracking error signal is substantially the maximum in the recorded region and a predetermined coefficient as being the inclination of the objective lens when the amplitude of the RF signal is substantially the maximum in the recorded region or the jitter is substantially the minimum in the recorded region.

33. The computer program product according to claim 28 wherein the method further comprises a step of acquiring, prior to the step of acquiring the tilt control information, a relation between the amplitude of the tracking error signal in the recording region and the inclination of the objective lens, and in the step of aquiring the relation, the amplitude of the tracking error signal in the recording region is corrected using a ratio of amplitudes of the tracking error signal before and after recording the data in the recorded region.

34. The computer program product according to claim 28 wherein the track of the optical disk is divided into a plurality of write regions for tilt control at the time of recording, and the tilt control information is aquired for each of the plurality of write regions, and the method further comprising steps of:
determining whether the tilt control information acquired in the tilt control information acquiring step for a specific write region among the plurality of write regions in which the recording region is included is valid, based on each of the tilt control information acquired for two of the plurality of write regions located before and after the specific write region; and
canceling the tilt control information acquired in the tilt control information acquiring step to perform an error processing when it is determined in the determining step that the tilt control information is invalid.

35. The computer program product according to claim 34 wherein, in the error processing, the tilt control information for the specific write region is estimated based on each of the tilt control information acquired for the two of the plurality of write regions located before and after the specific write region, and the estimated tilt control information is determined as being the tilt control information for the specific write region.

36. The computer program product according to claim 34 wherein, in the error processing, the tilt control information acquiring step is repeated so that the tilt control information is acquired again.

37. The computer program product according to claim 34 wherein, when the recording region is overlapped over a first write region and a second write region among the plurality of write regions and a data writing position changes from the first write region to the second write region during recording of the data, the method further comprises a step of adjusting the inclination of the objective lens so that the inclination of the objective lens changes gradually near a boundary of the first write region and the second write region.

38. The computer program product according to claim 28 wherein the method further comprises steps of:
reproducing the data from the optical disk; and
controlling, when reproducing the data from the optical disk, the inclination of the objective lens based on tilt control information acquired near a central part of the track of the optical disk.

39. The computer program product according to claim 34 wherein the track of the optical disk is divided into a plurality of read regions for tilt control at the time of reproducing, the tilte control method further comprising steps of:
reproducing the data from the optical disk; and
controlling, when reproducing the data from the optical disk, the inclination of the objective lens based on tilt control information acquired near a central part of a specific read region among the plurality of read regions in which a reproducing region where the data is reproduced is included.

40. The computer program product according to claim 38 wherein, in the step of controlling the inclination of the objective lens, the tilt control information acquired near the central part of the track of the optical disk is corrected based on known information related to a difference between an optimal inclination of the objective lens at the time of recording and an optimal inclination of the objective lens at the time of reproduction.

41. A computer program product embodied therein to cause a computer of an optical disk drive to execute a tilt control method which controls an inclination of an objective lens to an optical disk in which a track in the shape of a spiral or a concentric circle is formed, the method comprising steps of:
reproducing data from the optical disk;
acquiring, when reproducing the data from the optical disk, tilt control information acquired near a central part of the track of the optical disk and provided for controlling the inclination of the objective lens; and
controlling the inclination of the objective lens based on the acquired tilt control information.

42. The computer program product according to claim 41 wherein the method further comprises a step of acquiring information related to an amplitude change of a tracking error signal or an RF signal before and after controlling the inclination of the objective lens.

43. An optical disk drive which accesses an optical disk in which a track in the shape of a spiral or a concentric circle is formed, the optical disk drive configured to control an inclination of an objective lens to the optical disk and comprising:
a tilt control information acquisition unit acquiring, when recording data to the disk, tilt control information for controlling the inclination of the objective lens based on both known compensation information that is defined with a plurality of kinds of signals acquired when reproducing data from a recorded region of the optical disk, and information that is related to an inclination of the objective lens when an amplitude of a tracking error signal is substantially a maximum in a recording region of the optical disk where the data are recorded;
an optical pickup device irradiating a light beam to a recording surface of the disk and receiving a reflected light from the recording surface of the disk; and
a processing unit performing at least recording of the data to the disk by using an output signal of the optical pickup device.

44. The optical dsik drive according to claim 43 further comprising a compensation information acquisition unit acquiring, as the known compensation information, information related to a difference between an inclination of the objective lens when the amplitude of the tracking error signal is substantially a maximum in the recorded region and an inclination of the objective lens when an amplitude of an RF signal is substantially a maximum in the recorded region or an jitter is substantially an minimum in the recorded region.

45. The optical dsik drive according to claim 44 further comprising an error-processing unit performing an error processing when the inclination of the objective lens with the amplitude of the RF signal beng substantially the maximum in the recorded region or the jitter being substantially the minimum in the recorded region is less than a predetermined value.

46. The optical disk drive according to claim 45 wherein the error-processing unit is configured to cancel the acquired compensation information and acquire new first inclination information related to an inclination of the objective lens when the amplitude of the tracking error signal is substantially a maximum in a new recorded region of the optical disk different from said recorded region, and new second inclination information related to an inclination of the objective lens when the amplitude of the RF signal is substantially the maximum in the new recorded region or the jitter is substantially the minimum in the new recorded region.

47. The optical disk drive according to claim 45 wherein the error-processing unit is configured to cancel the acquired compensation information and acquire new second inclination information by determining a value of multiplication of the inclination of the objective lens when the amplitude of the tracking error signal is substantially the maximum in the recorded region and a predetermined coefficient as being the inclination of the objective lens when the amplitude of the RF signal is substantially the maximum in the recorded region or the jitter is substantially the minimum in the recorded region.

48. The optical disk drive according to claim 43 further comprising a tracking-error-signal amplitude compensation unit acquiring, prior to the acquiring of the tilt control information, a relation between the amplitude of the tracking error signal in the recording region and the inclination of the objective lens, wherein, when aquiring the relation, the amplitude of the tracking error signal in the recording region is corrected using a ratio of amplitudes of the tracking error signal before and after recording the data in the recorded region.

49. The optical disk drive according to claim 43 wherein the track of the optical disk is divided into a plurality of write regions for tilt control at the time of recording, and the tilt control information is aquired for each of the plurality of write regions, and the optical disk drive further comprising:
a determination unit determining whether the tilt control information acquired by the tilt control information acquisition unit for a specific write region among the plurality of write regions in which the recording region is included is valid, based on each of the tilt control information acquired for two of the plurality of write regions located before and after the specific write region; and
an error-processing unit canceling the tilt control information acquired by the tilt control information acquisition unit to perform an error processing when it is determined that the tilt control information is invalid.

50. The optical disk drive according to claim 49 wherein the error processing unit is configured to estimate the tilt control information for the specific write region based on each of the tilt control information acquired for the two of the plurality of write regions located before and after the specific write region, so that the estimated tilt control information is determined as being the tilt control information for the specific write region.

51. The optical disk drive according to claim 49 wherein the error processing unit is configured to repeat the tilt control information acquisition of the tilt control information acquisition unit so that the tilt control information is acquired again.

52. The optical disk drive according to claim 49 wherein, when the recording region is overlapped over a first write region and a second write region among the plurality of write regions and a data writing position changes from the first write region to the second write region during recording of the data, and the optical disk drive further comprises an inclination change control unit adjusting the inclination of the objective lens so that the inclination of the objective lens changes gradually near a boundary of the first write region and the second write region.

53. The optical disk drive according to claim 49 further comprising a target beta-value setting unit setting a desired value of a beta value for each of the plurality of write regions, based on results of recording and reproduction of predetermined data to and from a power calibration area of the optical disk.

54. The optical disk drive according to claim 49 further comprising a target B-value setting unit setting a descired value of a B value for each of the plurality of write regions, based on results of recording and reproduction of predetermined data to and from a power calibration area of the optical disk.

55. The optical disk drive according to claim 43 further comprising an inclination control unit controlling, when reproducing the data from the optical disk, the inclination of the objective lens based on tilt control information acquired near a central part of the track of the optical disk.

56. The optical disk drive according to claim 49 wherein the track of the optical disk is divided into a plurality of read regions for tilt control at the time of reproducing, and the optical disk drive further comprising an inclination control unit controlling, when reproducing the data from the optical disk, the inclination of the objective lens based on tilt control information acquired near a central part of a specific read region among the plurality of read regions in which a reproducing region where the data is reproduced is included.

57. The optical disk drive according to claim 55 further comprising a compensation unit correcting the tilt control information acquired near the central part of the track of the optical disk based on known information related to a difference between an optimal inclination of the objective lens at the time of recording and an optimal inclination of the objective lens at the time of reproduction.

58. An optical disk drive which accesses an optical disk in which a track in the shape of a spiral or a concentric circle is formed, the optical disk drive configured to control an inclination of an objective lens to the optical disk and comprising:
an inclination control unit controlling, when reproducing data from the disk, the inclination of the objective lens based on tilt control information acquired near a central part of the track of the optical disk;
an optical pickup device irradiating a light beam to a recording surface of the disk and receiving a reflected light from the recording surface of the disk; and
a processing unit performing at least reproducing of the data from the disk by using an output signal of the optical pickup device.

59. The optical disk drive according to claim 58 further comprising an amplitude change acquisition unit acquiring information related to an amplitude change of a tracking error signal or an RF signal before and after controlling the inclination of the objective lens.

60. The optical disk drive according to claim 59 further comprising an amplitude change detection unit detecting whether there is an amplitude change of the tracking error signal or the RF signal before and after a stop of movement of the objective lens when the objective lens is moved in a seeking operation.

61. The optical disk drive according to claim 60 further comprising:
a memory unit in which the tilt control information is stored;
a temperature detection unit detecting a temperature near the objective lens; and
a storing unit for correlating the tilt control information with temperature information detected by the temperature detection unit, and storing the tilt control information into the memory unit.
